(19) United States
(12) Patent Application Publication
(10) Pub. No.: US 2026/0040315 A1
(43) Pub. Date: Feb. 5, 2026

(54) METHODS AND APPARATUSES OF AN ENHANCED TRANSMISSION ON A PRECONFIGURED RESOURCE

(71) Applicant: Lenovo (Beijing) Limited, Beijing (CN)

(72) Inventors: Xiaoying Xu, Shanghai (CN); Mingzeng Dai, Shanghai (CN); Lianhai Wu, Beijing (CN); Jing Han, Beijing (CN); Congchi Zhang, Shanghai (CN); Haiyan Luo, Shanghai (CN)

(73) Assignee: Lenovo (Beijing) Limited, Beijing (CN)

(21) Appl. No.: 19/100,707

(22) PCT Filed: Aug. 3, 2022
(86) PCT No.: PCT/CN2022/110114

§ 371 Date: Feb. 3, 2025

(51) Int. Cl. H04W 72/21; H04W 28/02; H04W 72/0446

(52) U.S. Cl. CPC H04W 72/21; H04W 28/0278; H04W 72/0446

(57) ABSTRACT

Embodiments of the subject application relate to methods and apparatuses of an enhanced transmission on a preconfigured resource for extended reality (XR) traffic. According to an embodiment of the subject application, a user equipment (UE) includes a processor and a transceiver coupled to the processor; and the processor is configured to: determine to skip a physical uplink share channel (PUSCH) resource for an uplink (UL) data transmission within one or more configured grants (CG)s or a bundle of CG or a subset of the bundle of CG in response to fulfillment of a set of conditions, wherein the set of conditions include at least one of: upon reception of a dynamic UL grant (DG), wherein the DG is in a time window of the bundle of CG or the bundle of CG follows the DG; upon reception of the DG and upon transmission on at least one PUSCH resource on the DG; upon transmission over a PUSCH resource within the bundle of CG; upon transmission of a scheduling request (SR) over a first physical uplink control channel (PUCCH) resource ahead of the bundle of CG; or upon transmission of all available data for transmission over one or more PUSCII resources within the bundle of CG; upon reception of a second DG, wherein the second DG overlaps with a CG within the one or more CGs; upon reception of the second DG and upon transmission on at least one PUSCH resource on the second DG; upon transmission over a PUSCII resource in a CG within the one or more CGs; upon transmission of a SR over a PUCCII resource ahead of a CG within the one or more CGs; upon transmission of all available data for transmission over one or more PUSCH resources in the one or more CGs; or upon reception of a cancel indication of the bundle of CG or the one or more CGs.

### TECHNICAL FIELD

Embodiments of the subject application generally relate to wireless communication technology, in particular to methods and apparatuses of an enhanced transmission on a preconfigured resource for extended reality (XR) traffic.

### BACKGROUND

Extended reality (XR), including augmented reality (AR) and virtual reality (VR), as well as cloud gaming (CG), presents a new promising category of connected devices, applications, and services. As a potential working area of 3GPP (3rd generation partnership project) Rel-18, power saving of a XR device is one of key topics. Currently, details regarding an enhanced transmission on a preconfigured resource for XR traffic have not been discussed yet.

### SUMMARY

Some embodiments of the subject application also provide a user equipment (UE). The UE includes a processor and a transceiver coupled to the processor; and the processor is configured to: determine to skip a physical uplink share channel (PUSCH) resource for an uplink (UL) data transmission within one or more configured grants (CG)s or a bundle of CG or a subset of the bundle of CG in response to fulfillment of a set of conditions, wherein the set of conditions include at least one of: upon reception of a dynamic UL grant (DG), wherein the DG is in a time window of the bundle of CG or the bundle of CG follows the DG; upon reception of the DG and upon transmission on at least one PUSCH resource on the DG; upon transmission over a PUSCH resource within the bundle of CG; upon transmission of a scheduling request (SR) over a physical uplink control channel (PUCCH) resource ahead of the bundle of CG; upon transmission of all available data for transmission over one or more PUSCH resources within the bundle of CG; upon reception of a second DG wherein the second DG overlaps with a CG within the one or more CGs; upon reception of the second DG and upon transmission on at least one PUSCH resource on the second DG; upon transmission over a PUSCH resource in a CG within the one or more CGs; upon transmission of a SR over a PUCCH resource ahead of a CG within the one or more CGs; upon transmission of all available data for transmission over one or more PUSCH resources in the one or more CGs; or upon reception of a cancel indication of the bundle of CG or the one or more CGs.

In some embodiments, the processor of the UE is configured to determine to skip all remaining PUSCH resource within the one or more CGs or the bundle of CG or the subset of the bundle of CG.

In some embodiments, in response to that the DG is in the time window of the bundle of CG or the bundle of CG follows the DG: the at least one PUSCH resource on the DG is overlapped with at least one PUSCH resource within the bundle of CG; or the at least one PUSCH resource on the DG is not overlapped with any PUSCH resource within the bundle of CG.

In some embodiments, the set of conditions further include at least one of: the DG can accommodate all available data for transmission; a buffer status report (BSR) or data is transmitted over the PUSCH resource within the bundle of CG; all remaining PUSCH resource following the PUSCH resource within the bundle of CG cannot accommodate remaining available data for transmission; or a time interval between the PUCCH resource for the SR and a PUSCH resource firstly appeared in a time domain within the bundle of CG is greater than or equal to a threshold.

In some embodiments, the processor of the UE is configured to determine the subset of the bundle of CG from the bundle of CG based on at least one of: a total number of PUSCH resources within the subset of the bundle of CG and a start PUSCH resource within the subset of the bundle of CG; or a time period of the subset of the bundle of CG in a time domain and a start time point of the time period.

In some embodiments, the processor of the UE is configured to receive an enhanced CG skip configuration via the transceiver from a network node, and wherein the enhanced CG skip configuration is associated with at least one of: the threshold; the total number of PUSCH resources within the subset of the bundle of CG; the time period of the subset of the bundle of CG in the time domain; information indicating corresponding relationship between a PUCCH resource for transmitting a signal and a CG within the bundle of CG; or information indicating corresponding relationship between a PUCCH resource for transmitting uplink control information (UCI) and the CG within the bundle of CG.

In some embodiments, the start time point is determined based on: a PUSCH resource in the time domain overlapping with the DG; or a physical downlink control channel (PDCCH) resource scheduling the DG.

In some embodiments, the start time point is determined based on: the PUSCH resource for a buffer status report (BSR) or data.

In some embodiments, the start time point is determined based on the one or more PUSCH resources within the bundle of CG for the transmission of all available data for transmission.

In some embodiments, the processor of the UE is configured to transmit a notification message via the transceiver to the network node, and wherein the notification message indicates that the bundle of CG or the subset of the bundle of CG is being skipped or to be skipped.

In some embodiments, the notification message is transmitted in at least one of: a medium access control (MAC) control element (CE); or a signal or uplink control information (UCI) on a PUCCH resource.

In some embodiments, the notification message includes information used to indicate at least one of: a CG configuration index related to a CG within the bundle of CG; a CG configuration index related to the bundle of CG; a start PUSCH resource being skipped or to be skipped; a first offset associated with the start PUSCH resource; an end PUSCH resource being skipped or to be skipped; a second offset associated with the end PUSCH resource; a time length of the subset of the bundle of CG; a total number of PUSCH resources of the subset of the bundle of CG; or the bundle of CG.

In some embodiments, the processor of the UE is configured to: receive an enhanced CG configuration associated with the bundle of CG related to one set of CG configuration or one or more sets of CG configurations and determine the bundle of CG or the one or more CGs based on the enhanced CG configuration, wherein the bundle of CG is for only one or more new transmissions or is for one or more repetition transmission; or receive multiple sets of CG configurations and determine the bundle of CG based on the multiple sets of CG configurations.

In some embodiments, the enhanced CG configuration includes at least one of: first information to indicate each of PUSCH resources within the bundle of CG for only one or more new transmissions; second information to indicate a part of the PUSCH resources within the bundle of CG for only one or more new transmissions or for one or more repetition transmissions; an offset of a hybrid automatic repeat request (HARQ) process identifier (ID) for at least one PUSCH resource within the bundle of CG; a time reference system frame number (SFN), wherein the closest time reference SFN preceding reception of the enhanced CG configuration is used by the UE; an integer period for the bundle of CG; or a non-integer period for the bundle of CG.

In some embodiments, the first information is a total number of PUSCH resources within the bundle of CG, wherein the second information is a resource bitmap indication, and wherein each bit position within the resource bitmap indication corresponds to a resource within the bundle of CG.

In some embodiments, the processor of the UE is configured to determine a HARQ process ID for at least one PUSCH resource within the bundle of CG based on the offset of HARQ process ID.

Some embodiments of the subject application also provide a user equipment (UE). The UE includes a processor and a transceiver coupled to the processor; and the processor is configured to: receive an enhanced resource configuration via the transceiver from a network node, wherein the enhanced resource configuration includes at least one of: first information to indicate resources within a bundle of preconfigured resources; second information to indicate a part of the resources within the bundle of preconfigured resources; an offset of hybrid automatic repeat request (HARQ) process identifier (ID) for at least one resource within the bundle of preconfigured resources; a time reference system frame number (SFN), wherein the closest time reference SFN preceding reception of the enhanced resource configuration is used by the UE; an integer period for the bundle of preconfigured resources; or a non-integer period for the bundle of preconfigured resources.

In some embodiments, the bundle of preconfigured resources includes at least one of: a bundle of PUSCH resources of configured grant (CG) for only one or more new transmissions or for one or more repetition transmissions; a PUCCH resource of scheduling request (SR) or a bundle of PUCCH resource of SR; a PDSCH resource of semi-persistent scheduling (SPS) or a bundle of PDSCH resource of SPS; or a signal or uplink control information (UCI) for a notification message associated with a CG skip operation of the UE.

In some embodiments, the first information is a total number of resources within the bundle of preconfigured resources, wherein the second information is a resource bitmap indication, and wherein each bit position within the resource bitmap indication corresponds to a resource within the bundle of preconfigured resources.

In some embodiments, the processor of the UE is configured to determine an available or valid or consecutive resource allocation within the bundle of preconfigured resources in a time domain based on the first information.

In some embodiments, the processor of the UE is configured to determine an available or valid or inconsecutive resource allocation within the bundle of preconfigured resources in a time domain based on the second information.

In some embodiments, the processor of the UE is configured to determine at least one of: a first resource firstly appeared in the time domain within the bundle of preconfigured resources based on the integer period or the non-integer period; or at least one additional resource within the bundle of preconfigured resources except the first resource based on the first information.

In some embodiments, the processor of the UE is configured to determine a HARQ process ID for a resource within the bundle of preconfigured resources based on the offset of HARQ process ID.

In some embodiments, the processor of the UE is configured to transmit information regarding a capability supporting a CG skip operation via the transceiver to a network node.

In some embodiments, the processor of the UE is configured to transmit a notification message via the transceiver to the network node, and wherein the notification message indicates that the bundle of preconfigured resources or a subset of the bundle of preconfigured resources is being skipped or to be skipped.

In some embodiments, the notification message is transmitted in at least one of: a medium access control (MAC) control element (CE); or a signal or uplink control information (UCI) on a PUCCH resource.

In some embodiments, the notification message includes information used to indicate at least one of: a CG configuration index related to a CG within the bundle of CG; a CG configuration index related to the bundle of CG; a start PUSCH resource being skipped or to be skipped; a first offset associated with the start PUSCH resource; an end PUSCH resource being skipped or to be skipped; a second offset associated with the end PUSCH resource; a time length of the subset of the bundle of preconfigured resources; a total number of resources of the subset of the bundle of preconfigured resources; or the bundle of preconfigured resources.

In some embodiments, the notification message is transmitted in response to fulfillment of a set of conditions, and wherein the set of conditions include at least one of: upon reception of a dynamic UL grant (DG), and the DG is in a time window of the bundle of preconfigured resources or ahead of the bundle of preconfigured resources; upon reception of the DG and upon transmission on at least one PUSCH resource on the DG; upon transmission over a resource within the bundle of preconfigured resources; upon transmission of a scheduling request (SR) over a first physical uplink control channel (PUCCH) resource ahead of the bundle of preconfigured resources; or upon transmission of all available data for transmission over one or more PUSCH resources within the bundle of preconfigured resources.

In some embodiments, in response to that the DG is in the time window of the bundle of preconfigured resources: the at least one resource on the DG is overlapped with at least one resource within the bundle of preconfigured resources; or the at least one resource on the DG is not overlapped with a resource within the bundle of preconfigured resources.

In some embodiments, the set of conditions further include at least one of: the DG can accommodate the all available data for transmission; a buffer status report (BSR) or data is transmitted over the resource within the bundle of preconfigured resources; all remaining resource following the resource within the bundle of preconfigured resources cannot accommodate remaining available data for transmission; or a time interval between the PUCCH resource for the SR and a resource firstly appeared in the time domain within the bundle of preconfigured resources is greater than or equal to a threshold.

In some embodiments, the processor of the UE is configured to determine the subset of the bundle of preconfigured resources based on at least one of: a total number of resources within the subset of the bundle of preconfigured resources and a start resource within the subset of the bundle of preconfigured resources; or a time period of the subset of the bundle of preconfigured resources in the time domain and a start time point of the time period.

In some embodiments, the enhanced resource configuration is associated with at least one of: the threshold; the total number of resources within the subset of the bundle of preconfigured resources; the time period of the subset of the bundle of preconfigured resources in the time domain; information indicating relationship between a PUCCH resource for transmitting a signal and a CG within the bundle of preconfigured resources; or information indicating relationship between a PUCCH resource for transmitting uplink control information (UCI) and the CG within the bundle of preconfigured resources.

In some embodiments, the start time point is determined based on: a resource in the time domain overlapping with the DG; or a physical downlink control channel (PDCCH) resource scheduling the DG.

In some embodiments, the start time point is determined based on the resource within the bundle of preconfigured resources for a buffer status report (BSR) or data.

In some embodiments, at least two resources within the bundle of preconfigured resources are related to one set of resource configuration; or the at least two resources within the bundle of preconfigured resources are related to different sets of resource configurations.

Some embodiments of the subject application also provide a network node (e.g., a base station (BS)). The network node includes a processor and a transceiver coupled to the processor; and the processor is configured to transmit an enhanced resource configuration via the transceiver to the UE, wherein the enhanced resource configuration includes at least one of: first information to indicate resources within a bundle of preconfigured resources; second information to indicate a part of the resources within the bundle of preconfigured resources; an offset of hybrid automatic repeat request (HARQ) process identifier (ID) for at least one resource within the bundle of preconfigured resources; a time reference system frame number (SFN), wherein the closest time reference SFN preceding reception of the enhanced resource configuration is used by the UE; an integer period for the bundle of preconfigured resources; or a non-integer period for the bundle of preconfigured resources.

In some embodiments, the bundle of preconfigured resources includes at least one of: a bundle of PUSCH resources of configured grant (CG) for only one or more new transmissions or for one or more repetition transmissions; a PUCCH resource of scheduling request (SR) or a bundle of PUCCH resource of SR; a PDSCH resource of semi-persistent scheduling (SPS) or a bundle of PDSCH resource of SPS; or a signal or uplink control information (UCI) for a notification message associated with a CG skip operation of the UE.

In some embodiments, the first information is a total number of resources within the bundle of preconfigured resources, wherein the second information is a resource bitmap indication, and wherein each bit position within the resource bitmap indication corresponds to a resource within the bundle of preconfigured resources.

In some embodiments, the processor of the network node is configured to receive a notification message via the transceiver from the UE, and wherein the notification message indicates that the bundle of preconfigured resources or a subset of the bundle of preconfigured resources is being skipped or to be skipped.

In some embodiments, the notification message is in at least one of: a medium access control (MAC) control element (CE); or a signal or uplink control information (UCI) on a PUCCH resource.

In some embodiments, the notification message includes information used to indicate at least one of: a CG configuration index related to a CG within the bundle of CG; a CG configuration index related to the bundle of CG; a start PUSCH resource being skipped or to be skipped; a first offset associated with the start PUSCH resource; an end PUSCH resource being skipped or to be skipped; a second offset associated with the end PUSCH resource; a time length of the subset of the bundle of preconfigured resources; a total number of resources of the subset of the bundle of preconfigured resources; or the bundle of preconfigured resources.

In some embodiments, the enhanced resource configuration is associated with at least one of: a threshold associated with a time interval between the PUCCH resource for the SR and a resource firstly appeared in the time domain within the bundle of preconfigured resources; a total number of resources within the subset of the bundle of preconfigured resources; a time period of the subset of the bundle of preconfigured resources in the time domain; information indicating relationship between a PUCCH resource for transmitting a signal and a CG within the bundle of preconfigured resources; or information indicating relationship between a PUCCH resource for transmitting uplink control information (UCI) and the CG within the bundle of preconfigured resources.

Some embodiments of the subject application provide a method, which may be performed by a UE. The method includes: determining to skip a physical uplink share channel (PUSCH) resource for an uplink (UL) data transmission within one or more configured grants (CG)s or a bundle of CG) or a subset of the bundle of CG in response to fulfillment of a set of conditions, and wherein the set of conditions include at least one of: upon reception of a dynamic UL grant (DG), and the DG is in a time window of the bundle of CG or ahead of the bundle of CG; upon reception of the DG and upon transmission on at least one PUSCH resource on the DG; upon transmission over a PUSCH resource within the bundle of CG; upon transmission of a scheduling request (SR) over a first physical uplink control channel (PUCCH) resource ahead of the bundle of CG; or upon transmission of all available data for transmission over one or more PUSCH resources within the bundle of CG; upon reception of a second DG, wherein the second DG overlaps with a CG within the one or more CGs; upon reception of the second DG and upon transmission on at least one PUSCH resource on the second DG; upon transmission over a PUSCH resource in a CG within the one or more CGs; upon transmission of a SR over a PUCCH resource ahead of a CG within the one or more CGs; upon transmission of all available data for transmission over one or more PUSCH resources in the one or more CGs; or upon reception of a cancel indication of the bundle of CG or the one or more CGs.

Some embodiments of the subject application provide a method, which may be performed by a UE. The method includes: receiving an enhanced resource configuration from a network node, wherein the enhanced resource configuration includes at least one of: first information to indicate resources within a bundle of preconfigured resources; second information to indicate a part of the resources within the bundle of preconfigured resources; an offset of hybrid automatic repeat request (HARQ) process identifier (ID) for at least one resource within the bundle of preconfigured resources; a time reference system frame number (SFN), wherein the closest time reference SFN preceding reception of the enhanced resource configuration is used by the UE; an integer period for the bundle of preconfigured resources; or a non-integer period for the bundle of preconfigured resources.

Some embodiments of the subject application provide a method, which may be performed by a network node (e.g., a BS). The method includes: transmitting an enhanced resource configuration to the UE, wherein the enhanced resource configuration includes at least one of: first information to indicate resources within a bundle of preconfigured resources; second information to indicate a part of the resources within the bundle of preconfigured resources; an offset of hybrid automatic repeat request (HARQ) process identifier (ID) for at least one resource within the bundle of preconfigured resources; a time reference system frame number (SFN), wherein the closest time reference SFN preceding reception of the enhanced resource configuration is used by the UE; an integer period for the bundle of preconfigured resources; or a non-integer period for the bundle of preconfigured resources.

Some embodiments of the subject application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a ULE or a network node (e.g., a BS).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the subject application.

FIG. 2 illustrates an exemplary schematic diagram of XR traffic in accordance with some embodiments of the subject application.

FIG. 3 illustrates an exemplary schematic diagram of non-integer periodicity of XR traffic in accordance with some embodiments of the subject application.

FIGS. 4A, 4B, and 5 illustrate exemplary schematic diagrams of a bundle of CG skip operation based on a dynamic UL grant (DG) in accordance with some embodiments of the subject application.

FIG. 6 illustrates an exemplary schematic diagram of a bundle of CG skip operation based on a CG transmission in accordance with some embodiments of the subject application.

FIG. 7 illustrates an exemplary schematic diagram of a bundle of CG skip operation based on a SR transmission in accordance with some embodiments of the subject application.

FIG. 8 illustrates an exemplary schematic diagram of spare PUSCH resources within a bundle of CG Type 1 in accordance with some embodiments of the subject application.

FIG. 9 illustrates a block diagram of an exemplary apparatus in accordance with some embodiments of the present disclosure.

### DETAILED DESCRIPTION

The detailed description of the appended drawings is intended as a description of preferred embodiments of the subject application and is not intended to represent the only form in which the subject application may be practiced. It should be understood that the same or equivalent functions may be accomplished by different embodiments that are intended to be encompassed within the spirit and scope of the subject application.

Reference will now be made in detail to some embodiments of the subject application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced, 6G, and so on. It is contemplated that along with developments of network architectures and new service scenarios, all embodiments in the subject application are also applicable to similar technical problems; and moreover, the terminologies recited in the subject application may change, which should not affect the principle of the subject application.

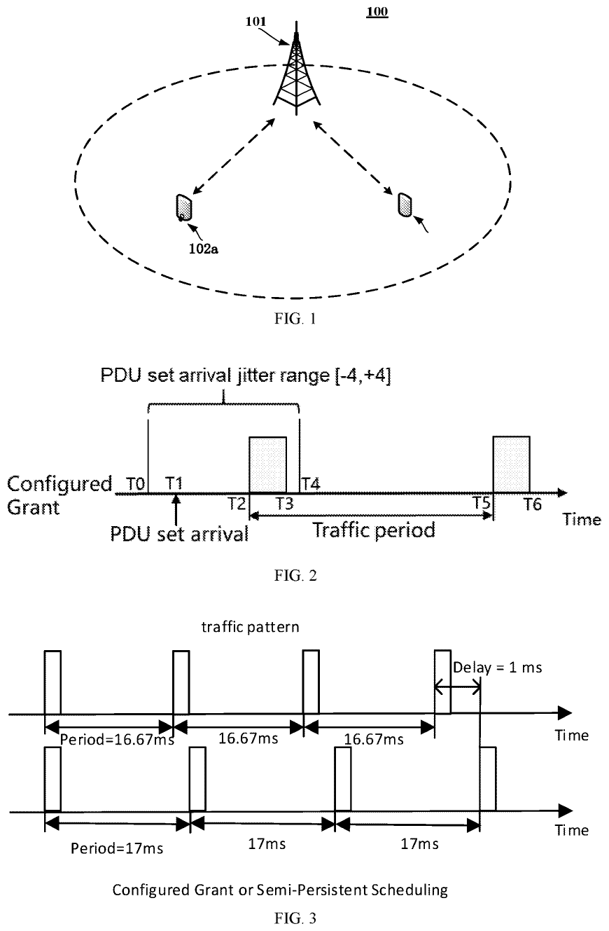

FIG. 1 illustrates a schematic diagram of a wireless communication system in accordance with some embodiments of the subject application.

As shown in FIG. 1, the wireless communication system 100 includes at least one base station (BS) 101 and at least one UE 102. In particular, the wireless communication system 100 includes one BS 101 and two UEs 102 (e.g., UE 102a and UE 102b) for illustrative purpose. Although a specific number of BS 101 and UEs 102 are depicted in FIG. 1, it is contemplated that any number of BSs 101 and UEs 102 may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

BS 101 may also be referred to as a NG-RAN node, a RAN node, an access point, an access terminal, a base, a macro cell, a node-B, an enhanced node B (eNB), a gNB, a home node-B, a relay node, or a device, or described using other terminology used in the art. BS 101 is generally part of a radio access network that may include a controller communicably coupled to BS 101.

According to some embodiments of the subject application, UE(s) 102 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some other embodiments of the subject application, UE(s) 102 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the subject application, UE(s) 102 may include wearable devices, such as smart watches, fitness bands, optical head-mounted displays, or the like. Moreover, UE(s) 102 may be referred to as a subscriber unit, a mobile, a mobile station, a user, a terminal, a mobile terminal, a wireless terminal, a fixed terminal, a subscriber station, a user terminal, or a device, or described using other terminology used in the art.

Both UE 102a and UE 102b in the embodiments of FIG. 1 may transmit information to BS 101 and receive control information from BS 101, for example, via LTE or NR Uu interface.

Currently, as a potential working area of 3GPP Release 18, XR-specific capacity improvements are a key feature, e.g., mechanisms that provide more efficient resource allocation and scheduling for XR service characteristics (periodicity, multiple flows, jitter, latency, reliability, and etc.) are needed. However, the following issues are identified to impact the system capacity, e.g., as shown in FIGS. 2 and 3.

In one aspect, a size of a protocol data unit (PDU) set (PS) is variable. If resource(s) is allocated for matching the maximum PS size, it will cause resource(s) wasted and impact a XR device's capacity. A possible way is to allocate resource(s) for transmitting a BSR and a small amount of data, and the remaining data is up to a dynamic scheduling transmission. If the UL arrival has a jitter range (e.g., [−4, +4] as shown in FIG. 2) and less configured grants (CG)s are allocated, it would cause the transmission delay for the BSR and/or data. In the meanwhile, a network is not aware of the transmission delay, and the network cannot make a good schedule policy to not exceed the PUD set delay budget (PSDB) for XR devices. A possible way is to allocate multiple resource(s) for data transmission, if a UE only uses one of the resources for transmission, the over allocated resource is a waste.

For instance, FIG. 2 illustrates an exemplary schematic diagram of XR traffic in accordance with some embodiments of the subject application. Referring to FIG. 2, CGs are configured in time domain, e.g., from time points T2 to T3, and T5 to T6, with Traffic period as shown in FIG. 2. Traffic period may also be named as a UL XR traffic arrival period or the like. The embodiments of FIG. 2 assume that a PDU set arrival jitter range is [−4, +4], i.e., from time points T0 to T4. If a PDU set arrives at time point T1, the PDU set is not located within a time window of the configured CGs. Given this, this would cause the transmission delay for a BSR and/or data. In the meanwhile, since a network node is not aware of the transmission delay, the network node cannot make a good schedule policy to not exceed the PSDB.

In another aspect, a UL XR traffic arrival period may be a non-integer value. In order to match the XR traffic transmission, multiple CGs can be configured. In general, there are two types of CG: CG Type 1 where an uplink grant is provided by RRC, and stored as configured uplink grant; and CG Type 2 where an uplink grant is provided by PDCCH and stored or cleared as configured uplink grant based on Layer-1 signalling indicating configured uplink grant activation or deactivation. For CG Type 2, multiple resource activation commands and confirmations may be needed, but this is an inefficient procedure for the resource management. For CG Type 1, the signaling overhead to configure one or more set of CG configurations in an RRC message is also a bit larger.

For instance, FIG. 3 illustrates an exemplary schematic diagram of non-integer periodicity of XR traffic in accordance with some embodiments of the subject application. Referring to FIG. 3, XR traffic may be of 60 fps, of which a frame periodicity is 16.67 ms. In some embodiments, a discontinuous reception (DRX) cycle with a length of 17 ms may be used. However, using 17 ms DRX cycles will cause that the XR traffic may miss the on-duration time of a DRX cycle, because three 17 ms DRX cycles occupy 51 ms in time domain, while three 16.67 ms periods occupy 50 ms in time domain, and thus the Delay is 1 ms as shown in FIG. 3. Therefore, how to avoid the resource waste for the capacity improvement is required to be studied.

In general, in a case that the DG can accommodate all pending data for transmission, even there is no pending data transmission for a UE, there may be potential MAC CE triggered later to be transmitted on the bundle of CG or one or more CGs. If a network node reallocates the remaining resource(s) within the bundle of CG or one or more CGs to anther UE, both UEs may perform a transmission on the same resource, and both UEs have risk of a transmission failure. Thus, there is a need to define a UE's behaviour to skip a CG.

Given the above, embodiments of the subject application design mechanisms for balancing the transmission delay and resource waste for a XR device for the capacity enhancement. More specifically, in some embodiments of the subject application, a UE may skip PUSCH resource(s) within one or more CGs or a bundle of CG for a new transmission based on a dynamic grant or a BSR or data over a CG or a SR. In some embodiments of the subject application, a UE may send signalling to notify a network node about this kind of CG skip operation. After the network node is aware of the CG skip operation, the network node may reallocate the PUSCH resource(s) for other purpose.

In some embodiments of the subject application, a network node transmits an enhanced resource configuration to a UE, to enable a bundle of PUSCH resources of CG for only new transmission(s) or for one or more repetition transmission(s), a PUCCH resource of SR or a bundle of PUCCH resources of SR, a PDSCH resource of SPS or a bundle of PDSCH resources of SPS, or a signal or UCI for a notification message associated with a CG skip operation of the UE. In some embodiments of the subject application, a HARQ Process ID (HPID) is determined for each PUSCH within the bundle of CG. More details will be illustrated in the following text in combination with the appended drawings.

Some embodiments of the subject application provide an exemplary procedure performed by a UE (denoted as procedure #1 for simplicity). It should be appreciated by persons skilled in the art that the sequence of the operations in procedure #1 may be changed and that some of the operations in procedure #1 may be eliminated or modified, without departing from the spirit and scope of the disclosure. Details described in all other embodiments of the subject application are applicable for procedure #1. Moreover, details described in procedure #1 are applicable for all the embodiments of FIGS. 1-9.

In procedure #1, in order to reduce the preconfigured UL resource waste and assure that the remaining CG within the bundle of CG is available for a network node, a UE may skip the PUSCH transmission for all including potential MAC CE within multiple CG or the bundle of CG for a new transmission based on an SR transmission or a PUSCH (e.g., BSR/data) transmission over CG or a received dynamic UL grant (DG) or a PUSCH (e.g., BSR/data) transmission over DG. Optionally, the multiple CG is allowed for transmission of an LCH. In the meanwhile, the network node is aware of the CG skip is being skipped or to be skipped and may reallocate the PUSCH resource for other purpose. In the subject application, “skip” can be called a kind of “deactivate” or “suspend” or “cancel” or the like; a bundle of CG can be called a list of CG, a group of CG, multiple PUSCH resources in a CG or multiple PUSCH transmissions in a CG; a bundle of SPS can be called a list of SPS, a group of SPS, multiple PDSCH resources in a SPS or multiple PDSCH transmissions in a SPS; and a bundle of SR can be called a list of SR, a group of SR, multiple SR resources in a SR occasion or multiple SR transmissions in a SR occasion.

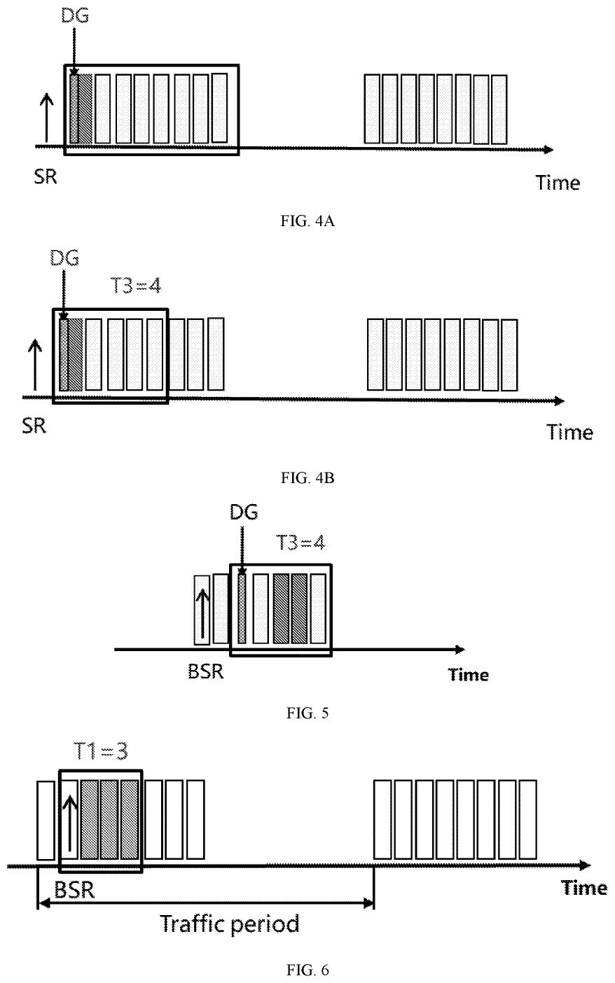

In particular, in procedure #1, a UE (e.g., UE 102 as shown in FIG. 1) may determine to skip a PUSCH resource for a UL data transmission within one or more CGs or a bundle of CG or a subset of the bundle of CG in response to fulfillment of a set of conditions. For example, the bundle of CG may be allowed for transmission of a logical channel (LCH). For example, the one or more CGs may be allowed for transmission of a logical channel (LCH). The set of conditions may include at least one of:
(1) Upon reception of a dynamic UL grant (DG). The DG occasion or the PDCCH occasion scheduling the grant may be in a time window of the bundle of CG or the bundle of CG may follow the DG, or the PSUCH duration of the DG is overlapping with the PSUCH duration of a CG in the one or more CGs or the DG is closest followed by one or more CGs. The time window may be from the first PUSCH resource to the last PUSCH resource within the bundle of CG. For example, the DG is allowed for transmission of the LCH. For example, if the interval between the DG occasion (or the PDCCH occasion scheduling the grant) and the bundle of CG or the subset of the bundle of CG or the one or more CGs or a subset of the one or more CGs is less than or equal to a predefined distance or a preconfigured distance by a network node, it may be considered as closest.
(2) Upon reception of the DG and upon transmission (for the LCH) on PUSCH resource(s) on the DG. Specific examples are described in embodiments of FIGS. 4A and 4B as follows.
(3) Upon transmission (for the LCH) over a PUSCH resource within the bundle of CG. Specific examples are described in embodiments of FIGS. 5 and 6 as follows.
(4) Upon transmission of a SR (for the LCH) over a PUCCH resource ahead of one of the multiple CG or the bundle of CG. Specific examples are described in embodiments of FIG. 7 as follows.
(5) Upon transmission of all available data for transmission (of the LCH) over PUSCH resource(s) within the multiple CG or the bundle of CG. For example, the buffer size of the data with the LCH equal to zero may also be transmitted.
(6) Upon reception of a DG which overlaps with a CG within the one or more CGs.
(7) Upon reception of the DG which overlaps with a CG within the one or more CGs and upon transmission on at least one PUSCH resource on the DG
(8) Upon transmission over a PUSCH resource in a CG within the one or more CGs; upon transmission of a SR over a PUCCH resource ahead of a CG within the one or more CGs.
(9) Upon transmission of all available data for transmission over one or more PUSCH resources in the one or more CGs.
(10) Upon reception of a cancel indication of the bundle of CG or the one or more CGs.

In some embodiments, the UE may determine to skip all remaining PUSCH resource within the one or more CGs or the bundle of CG or the subset of the bundle of CG.

In some embodiments, in response to that the cancel indication is received in the time window of the bundle of CG or the bundle of CG follows the cancel indication, the resource(s) (duration) for carrying the cancel indication is overlapped with PUSCH resource(s) (duration) within the bundle of CG, or not overlapped with any PUSCH resource (duration) within the bundle of CG. The cancel indication may be included in downlink control information (DCI) in PDCCH. The cancel indication may include at least one of: a CG configuration index to be cancelled, a total number of CG occasions to be cancelled, or a period of time within which resource(s) is to be cancelled.

In some embodiments, in response to that the DG occasion or the PDCCH occasion scheduling the grant is in the time window of the bundle of CG or the bundle of CG follows the DG, the PUSCH resource(s) (duration) on the DG is overlapped with PUSCH resource(s) (duration) within the bundle of CG, or not overlapped with any PUSCH resource (duration) within the bundle of CG.

In some embodiments, the set of conditions further include at least one of:
(1) The DG can accommodate all available data for transmission (of the LCH). Specific examples are described in embodiments of FIGS. 4A and 4B as follows.
(2) A BSR or data (of the LCH) is transmitted over the PUSCH resource within the multiple CG or the bundle of CG. Specific examples are described in embodiments of FIGS. 5 and 6 as follows. For example, the buffer size of the data with the LCH larger than zero may also be transmitted.
(3) All remaining PUSCH resource(s) following the PUSCH resource within the bundle of CG or all remaining PUSCH resource(s) in the one or more CGs closest following the PUSCH resource cannot accommodate remaining available data (of the LCH) for transmission. For example, in a case that a BSR of the LCH is triggered, the remaining available data of the LCH for transmission is indicated by the BSR. Specific examples are described in embodiments of FIG. 6 as follows. For example, if the interval between the PUSCH resource and the remaining PUSCH resources of the bundle of CG or the remaining part of the one or more CGs is less than or equal to a predefined distance or a preconfigured distance by a network node, it is considered as closest.
(4) A time interval between “the PUCCH resource for the SR” and “a PUSCH resource firstly appeared in a time domain within the one or more CGs or the bundle of CG” is greater than or equal to a threshold. Specific examples are described in embodiments of FIG. 7 as follows.

In procedure #1, in some embodiments, the UE may determine the part of the one or more CGs or the subset of the bundle of CG from the bundle of CG based on at least one of:
(1) a total number of PUSCH resources within the subset of the bundle of CG or part of the one or more CGs and a start PUSCH resource within the subset of the bundle of CG; or
(2) a time period of the subset of the bundle of CG or the part of the one or more CGs in a time domain and a start time point of the time period. Specific examples are described in embodiments of FIGS. 4A, 4B, and 6 as follows.

In procedure #1, in some embodiments, the UE may receive an enhanced CG skip configuration from a network node (e.g., BS 101 as shown in FIG. 1). The enhanced CG skip configuration may be associated with at least one of:
(1) the threshold;
(2) the total number of PUSCH resources within the part of the one or more CGs or the subset of the bundle of CG;
(3) the time period of the part of the one or more CGs or the subset of the bundle of CG in the time domain;
(4) information indicating corresponding relationship between a PUCCH resource for transmitting a signal and a CG within the one or more CGs or the bundle of CG; or
(5) information indicating corresponding relationship between a PUCCH resource for transmitting UCI and the CG within the one or more CGs or the bundle of CG.

In some embodiments, the start time point is determined based on:
(1) (a start symbol of) a PUSCH resource firstly appeared in the time domain overlapping with the DG;
(2) (an end symbol of) a PUSCH resource lastly appeared in the time domain overlapping with the DG;
(3) (a start symbol of) a PDCCH resource scheduling the DG;
(4) (an end symbol of) the PDCCH resource scheduling the DG;
(5) (a start symbol of) a PDCCH resource transmitting the cancel indicator; or
(6) (an end symbol of) the PDCCH resource transmitting the cancel indicator. Specific examples are described in embodiments of transmitting the cancel indicator in FIGS. 4A and 4B as follows.

In some embodiments, the start time point is determined based on:
(1) (a start symbol of) the one or more PUSCH resources within the one or more CGs or the bundle of CG for the transmission of all available data for transmission (of the LCH); or
(2) (an end symbol of) the one or more PUSCH resources within the one or more CGs or the bundle of CG for the transmission of all available data for transmission (of the LCH). Specific examples are described in embodiments of FIGS. 4A and 4B as follows.

In some embodiments, the start time point is determined based on:
(1) (a start symbol of) the PUSCH resource for a BSR or data (of the LCH); or
(2) (an end symbol of) the PUSCH resource for the BSR or the data (of the LCH). Specific examples are described in embodiments of FIG. 6 as follows.

In procedure #1, in some embodiments, the UE may transmit a notification message to the network node. The notification message may indicate that the closest bundle of CG or the closest subset of the bundle of CG or the closest part of the one or more CGs is being skipped or to be skipped. For example, if the interval between the signal transmission and the bundle of CG or the subset of the bundle of CG or the part of the one or more CGs is less than or equal to a predefined distance or a preconfigured distance by the network node, it is considered as closest. In an embodiment, the notification message is transmitted in a MAC CE and/or a signal or UCI on a PUCCH resource.

In some embodiments, the notification message includes information used to indicate at least one of:
(1) One or more CG configuration indexes related to a CG within the one or more CGs or related to the bundle of CG. For example, the CG configuration index related to the CG is used to indicate the index of unique CG configuration index in a bandwidth part (BWP) (e.g., configuredGrantConfigIndex-r16) or indicate the unique CG configuration index per MAC entity (e.g., ConfiguredGrantConfigIndexMAC-r16).
(2) One or more CG configuration indexes related to the bundle of CG or related to a CG in the one or more CGs. For example, the CG configuration index related to the bundle of CG or a CG in the one or more CGs is used to indicate the index of unique CG configuration index in a BWP (e.g., configuredGrantConfigIndex-r16) or indicate the unique CG configuration index per MAC entity (e.g., ConfiguredGrantConfigIndexMAC-r16).
(3) A start PUSCH resource being skipped or to be skipped.
(4) An offset associated with the start PUSCH resource.
(5) An end PUSCH resource being skipped or to be skipped.
(6) An offset associated with the end PUSCH resource.
(7) A time length of the subset of the bundle of CG
(8) A total number of PUSCH resources of the subset of the bundle of CG
(9) The bundle of CG. For example, the notification message indicates that the bundle of CG are being skipped or to be skipped. Specific examples are described in embodiments of FIGS. 5 and 6 as follows.

FIGS. 4A and 4B illustrate exemplary schematic diagrams of a bundle of CG skip operation or one or more CGs based on a DG in accordance with some embodiments of the subject application. In the embodiments of FIGS. 4A and 4B, a UE may skip a PUSCH transmission within one or more CGs or a bundle of CG upon reception of a DG overlapped with the CG or ahead of the CG optionally after an SR transmission. For instance, following operations may be performed in the embodiments of FIGS. 4A and 4B, i.e., operations 1-4.

In operation 1, a UE is configured with configuration(s) associated with a bundle of CG allowed for a new transmission for an LCH (e.g., LCH #1). The configuration(s) may be named as “enhanced resource configuration(s)” or the like. The configuration(s) may include at least one of:
(1) A total number of (consecutive) PUSCH resource(s) configured to the bundle of CG for new transmission(s), e.g., nrofPUSCH in Embodiment #1 as described below. For example, after determining the first PUSCH resource within the bundle of CG based on the timeDomainOffset, the bundle of CG includes additional (consecutive) PUSCH resource(s) with a total number of “nrofPUSCH−1”. The CG(s) within the bundle of CG may be of the same length in time domain. Where, timeDomainOffset is used to indicate an offset related to the reference SFN indicated by timeReferenceSFN.
(2) An offset of a HARQ process ID for PUSCH resource(s) within the bundle of CG for new transmission(s), e.g., harq-ProcID-Offset3 in Embodiment #1.

Based on the abovementioned configuration(s), the UE may determine the PUSCH resource for each CG within the bundle of CG and a HARQ process ID of each PUSCH resource within the bundle of CG, e.g., as described in Embodiment #1 as below.

In operation 2, the UE may receive an expected DG which is allowed to transmit data for LCH #1 maybe, e.g., after the UE transmits an SR triggered by LCH #1.

In operation 3, the UE performs the PUSCH transmission for LCH #1 on the DG (e.g., the UE transmits the BSR for data transmission of LCH #1 and/or the data of LCH #1).

In operation 4 (which is optional), if the DG can accommodate the available data for transmission of LCH #1, and if the PUSCH resource of the DG is ahead of the bundle of CG (or is subsequently followed by the bundle of CG) or is overlapped with PUSCH resource(s) of the one or more CGs or the bundle of CG in time domain, the UE may:
(1) skip all PUSCH resource(s) within the bundle of CG from the overlapped PUSCH duration of a CG, e.g., as shown in FIG. 4A;
(2) skip the closest PUSCH resource(s) within the one or more CGs; or
(3) skip PUSCH resource(s) within a time period (e.g., denoted as T3 for simplicity) within the one or more CGs or the bundle of CG from the overlapped PUSCH duration of a CG, e.g., as shown in FIG. 4B.

For instance, a start time point of T3 may be determined based on:
(1) A start symbol of a PUSCH resource firstly appeared in time domain overlapping with the DG (e.g., denoted as PUSCH resource #1). For example, the start time point of T3 is determined as the start symbol of PUSCH resource #1.
(2) An end symbol of a PUSCH resource lastly appeared in time domain overlapping with the DG (e.g., denoted as PUSCH resource #n). For example, the start time point of T3 is determined as a symbol after the end symbol of PUSCH resource #n.
(3) A start symbol of a PDCCH resource scheduling the DG. For example, the start time point of T3 is determined as the start symbol of the PDCCH resource.
(4) An end symbol of the PDCCH resource scheduling the DG. For example, the start time point of T3 is determined as a symbol after the end symbol of the PDCCH resource.

In some embodiments, T3 is a time period and may be calculated from a start symbol of the first PUSCH on the DG or from the start symbol of the PDCCH scheduling the DG. In some other embodiments, a length of T3 is a total number of PUSCH resource(s) and may be calculated from the first overlapped PUSCH or after the first PUSCH within the bundle of CG if no PUSCH duration is overlapped.

For instance, as shown in FIG. 4A, the UE may skip all PUSCH resource(s) within the one or more CGs or the bundle of CG during the current CG period. As shown in FIG. 4B, in a case that T3=4, the UE may skip four PUSCH resource(s) within the bundle of CG, and a start time point of T3 is determined based on an end symbol of a PUSCH resource lastly appeared in the time domain overlapping with the DG. That is, as shown in FIG. 4B, a start time point of T3 is after an end symbol of a PUSCH resource lastly appeared in the time domain overlapping with the DG.

In an embodiment of FIGS. 4A and 4B, following operations may be performed:

UL Grant reception

```
1> else if this uplink grant is a configured uplink grant configured with
  enahcedCGSkip:
  2> if there is overlapping PUSCH duration of an uplink grant (allowed for data of
    an LCH) addressed to CS-RNTI with NDI = 1 or C-RNTI which was not
    already de-prioritized, in the same BWP, whose priority is higher than or equal
    to the priority of the uplink grant; and
  2> if the uplink grant(s) is a configured uplink grant within a bundle of CG
    (allowed for data of an LCH) for new transmission.
      3> consider this uplink grant and the remaining uplink grant within a
      bundle of CG for new transmission as skipped uplink grant; or
      3> consider this uplink grant and the remaining uplink grant within T3
      length from the overlapped PUSCH within the one or more CGs or a
      bundle of CG for new transmission as skipped uplink grant.
```

In another embodiment of FIGS. 4A and 4B, following operations may be performed:

UL Grant reception

```
1> else if this uplink grant is a configured uplink grant configured with
  enahcedCGSkip:
  2> if there is overlapping PUSCH duration of an uplink grant addressed to
    CS-RNTI with NDI = 1 or C-RNTI which was not already de-prioritized, in
    the same BWP, whose priority is higher than or equal to the priority of the
    uplink grant; and
  2> if the addressed uplink grant accommodates the available data for
    transmission of an LCH which is allowed to be transmitted on the configured
    uplink grant; and
  2> if the uplink grant(s) is a configured uplink grant is allowed transmission for
    LCH.
      3> consider this uplink grant and the remaining uplink grant within a
      bundle of CG for new transmission as a skipped uplink grant; or
      3> consider this uplink grant and the remaining uplink grant within T3
      length from the overlapped PUSCH within the one or more CGs or a
      bundle of CG for new transmission as skipped uplink grant.
```

FIG. 5 illustrates an exemplary schematic diagram of a bundle of CG skip operation based on a DG in accordance with some embodiments of the subject application. In the embodiments of FIG. 5, a UE may skip a PUSCH transmission within one or more CGs or a bundle of CG upon reception of a DG overlapped to the CG after a BSR transmission over a PUSCH resource within one or more CGs or a bundle of CG. For instance, following operations may be performed in the embodiments of FIG. 5, i.e., operations A-C.

In operation A, a UE transmits a BSR triggered by an LCH (e.g., LCH #1) on the PUSCH resource within the one or more CGs or the bundle of CG for a new transmission.

In operation B, if the UE receives an expected DG which is allowed to transmit data for LCH #1, and optionally, if the DG can accommodate the available data for transmission of LCH #1, where the PUSCH transmission of the DG is overlapped to one or more PUSCH resource of the one or more CGs or bundle of the CG, the UE may:
(1) skip remaining PUSCH resource(s) within the bundle of CG from the overlapped PUSCH duration of a CG; or
(2) skip the closest PUSCH resource(s) within the one or more CGs; or
(3) skip remaining PUSCH resource(s) within a time period (e.g., denoted as T3 for simplicity) within the one or more CGs or the bundle of CG from the overlapped PUSCH duration of a CG.

In some embodiments, T3 is a time period and may be calculated from a start symbol of the first PUSCH on the DG or from a start symbol of the PDCCH scheduling the DG. In some other embodiments, a length of T3 is a total number of PUSCH resource(s) and may be calculated from the first overlapped PUSCH or after the first PUSCH within the bundle of CG if no PUSCH duration is overlapped.

In operation C (which is optional), the UE may send signalling to a network node to notify the CG skip operation, e.g., via a MAC CE or a SR. For example, the UE may send a SR on a PUCCH resource to notify that the nearest corresponding CG (or CG occurs or less than or at time of transmitting the SR plus offset time, e.g., T_{SR}+T_{OFFSET}) transmission is being skipped or to be skipped. This PUCCH resource transmitting the SR may be allocated specially to correspond to the CG for a cancel notification. For example, the UE may send a MAC CE including a CG configuration index to the network node to notify the nearest corresponding CG (or CG occurs at or less than, e.g., T_{SR}+T_{OFFSET}) transmission is being skipped or to be skipped.

FIG. 6 illustrates an exemplary schematic diagram of a bundle of CG skip operation based on a CG transmission in accordance with some embodiments of the subject application. In the embodiments of FIG. 6, a UE may skip PUSCH transmission within the one or more CGs or a bundle of CG after a BSR transmission over a PUSCH resource within the one or more CGs or a bundle of CG. For instance, following operations may be performed in the embodiments of FIG. 6, i.e., operations X-Z.

In operation X, a UE performs a PUSCH transmission for a BSR triggered for LCH #1 or for an all data of LCH #1 over a PUSCH resource within the one or more CGs or a bundle of CG.

In operation Y (which is optional), if the remaining PUSCH resource(s) within the bundle of CG or the close PUSCH resource(s) within the one or more CGs cannot accommodate all the available data for transmission of LCH #1 (or the remaining data volume of LCH #1 minus the data volume to be accommodated on the remaining PUSCH resources within the bundle of CG is greater than a size, or the remaining data volume of LCH #1 minus the data volume to be accommodated on the close PUSCH resource(s) within the one or more CGs is greater than a size).

If the UE performs a UL transmission for all data of LCH #1 over a PUSCH resource within a bundle of CG, the UE may:
(1) skip the remaining PUSCH resource(s) within the bundle of CG, or skip the closest PUSCH resource(s) within the one or more CGs, or
(2) skip the remaining PUSCH resource(s) within the bundle of CG within a time period (e.g., denoted as T1 for simplicity), skip the close PUSCH resource(s) within the one or more CGs within a time period (e.g., denoted as T1 for simplicity).

In some embodiments, T1 is a time period and may be calculated from the start or an end of the PUSCH transmission. In some other embodiments, a length of T1 is a total number of PUSCH resource(s) and may be calculated from the start of the PUSCH transmission or after the end the PUSCH transmission within the bundle of CG.

In some cases, T1 in the embodiments of FIG. 6 is similar to T3 in the embodiments of FIGS. 4A, 4B, and 5. For instance, as shown in FIG. 6, in a case that T1=3, the UE may skip three PUSCH resource(s) within the bundle of CG, and a start time point of T1 is determined based on an end symbol of a PUSCH resource for transmitting the BSR. That is, as shown in FIG. 6, a start time point of T1 is after an end symbol of a PUSCH resource for transmitting the BSR.

In operation Z (which is optional), the UE may send signalling to a network node to notify the CG skip or CG transmission, e.g., via a MAC CE or a SR. In an example, the UE may send a SR on a PUCCH resource to notify that the nearest corresponding CG transmission is being skipped or to be skipped. The “nearest” can be interpreted as the above-mentioned “closest”. This PUCCH SR resource may be allocated specially to correspond to the CG for the cancel notification. In a further example, the UE may send a MAC CE including a CG configuration index to a network node to notify that the nearest corresponding CG transmission is being skipped or to be skipped.

In an embodiment of FIG. 6, following operations may be performed:

HARQ Entity

If a configured uplink grant is configured with enahcedCGSkip and is allowed for
transmission for an LCH, after a PUSCH transmission within a bundle for BSR of the
LCH, and if the remaining uplink grant within the bundle of CG cannot accommodates
the available data for transmission of the LCH, the remaining transmissions (within T3
length from the starting or end of the PUSCH transmission) within the bundle of CG
skip; or
If a configured uplink grant is configured with enahcedCGSkip and is allowed for
transmission for an LCH, after a PUSCH transmission within a bundle for all the
available data for transmission of the LCH, the remaining transmissions (within T1
length from the starting or end of the PUSCH transmission) within the bundle of CG
skip.

FIG. 7 illustrates an exemplary schematic diagram of a bundle of CG skip operation based on a SR transmission in accordance with some embodiments of the subject application. In the embodiments of FIG. 7, a UE may skip the PUSCH transmission within a bundle of CG far away from an SR transmission. For instance, following operations may be performed in the embodiments of FIG. 7, i.e., operations (a) and (b).

In operation (a), if the interval between the start or the end of the SR transmission and the first PUSCH within the bundle of CG is more than a time period (e.g., denoted as T2 for simplicity), a UE may send a SR to a network node on a PUCCH resource to notify the network node that the bundle of CG is to be skipped; or if the interval between the SR transmission and the one PUSCH within the one or more CGs is more than a time period (e.g., denoted as T2 for simplicity), a UE may send a SR to a network node on a PUCCH resource to notify the network node that one or more CGs are to be skipped. For instance, this resource for the SR transmission is specially corresponding to the CG to be skipped. The bundle of CG or the one or more CGs is configured to be allowed for transmission of LCH #1.

In some embodiments, T2 is a time period and may be calculated from the starting or end of the SR transmission. In some other embodiments, a length of T2 is a total number of PUSCH resource(s) and may be calculated from a start of the SR transmission or an end of the SR transmission.

Else, in operation (a), if the time interval between the start or the end of the SR transmission and the first PUSCH within the bundle of CG is less than the time period (e.g., T2), the UE may perform at least one PUSCH transmission within the bundle of CG within the T2 length from the start or end of the SR transmission.

In operation (b), the UE may skip a PUSCH transmission within the bundle of CG which is T2 away from the SR transmission triggered for LCH #1.

In an embodiment of FIG. 7, following operations may be performed:

HARQ Entity

If a configured uplink grant is configured with enahcedCGSkip and is allowed for
transmission for an LCH, after a SR transmission of the LCH, and if the intervel
between the SR transmission and the first PUSCH within the bundle of CG allowed for
transmission of the LCH larger than or equals to T2, a UE skips the bundle of CG; or
If a configured uplink grant is configured with enahcedCGSkip and is allowed for
transmission for an LCH, after a SR transmission of the LCH, and if the intervel
between the SR transmission and the PUSCH resources within the bundle of CG
allowed for transmission of the LCH smaller than or equals to T2, a UE performs at
least one PUSCH transmission within the bundle of CG.

In some embodiments of the subject application, a network node configures a UE for supporting an enhanced CG skip (ECGS) function, e.g., in any of the embodiments of FIGS. 4A-7. For instance, following operations may be performed in these embodiments, i.e., operations (1)-(3).

In operation (1), a UE may transmit information regarding a capability supporting a CG skip operation to a network node. In operation (2), the network node may send enhanced CG skip (ECGS) configuration(s) to the UE, e.g., in RRC signaling, which is used to control the ECGS for data transmission of an LCH. The ECGS configuration(s) may include at least one of:
(1) Configuration(s) associated with a time period, e.g., T1 in the embodiments of FIG. 6, which is a time length value from a BSR transmission, e.g., from a start of a BSR transmission or the first symbol after an end of the BSR transmission.
(2) Configuration(s) associated with a time period, e.g., T2 in the embodiments of FIG. 7, which may be a time length value from an SR transmission, e.g., from a start symbol of a SR transmission or the first symbol after an end of the SR transmission.
(3) Configuration(s) associated with a time period, e.g., T3 in the embodiments of FIGS. 4A, 4B, and 5, which is a time length value from a received DG or a PDCCH scheduling a DG, e.g., from a start symbol of a received DG or a start symbol of a PDCCH scheduling a DG
(4) Configuration(s) associated with a CG for an LCH.
(5) Configuration(s) associated with a SR for an LCH.
(6) Configuration(s) associated with a notification signal (e.g., a SR) corresponding to a CG.

In operation (3), after the UE receives the ECGS configuration(s), the UE may configure the MAC entity and sends an RRC reconfiguration complete message to the network node.

Referring back to procedure #1, in order to reduce the preconfigured UL resource waste, a network node may configure sparse or a part of PUSCH transmission(s) within a bundle of CG or one or more CGs to a UE for communicating, and each of the PUSCH transmission(s) corresponds to a separate or same HARQ process.

In particular, in some embodiments, a UE may receive multiple sets of CG configurations (e.g., legacy CG configuration(s) as defined in 3GPP specifications) and may determine the bundle of CG based on the multiple sets of CG configurations which may be allowed for transmission of an LCH. For instance, a CG within the bundle of CG may be associated with one set of CG configuration corresponding to a CG configuration index in a BWP or a MAC entity. For instance, a CG within the one or more CGs may be associated with one set of CG configuration corresponding to a CG configuration index in a BWP or a MAC entity, and the set of CG configuration may include a periodicity and an offset of the CG within the one or more CGs and/or other configuration information, e.g., a frequency domain resource allocation, a start symbol and a length and a PUSCH mapping type, and/or a redundancy version (RV) sequence to use. During a time period, there may be one or more CGs each of which is configured with one respective set of CG configuration, and the UE may determine to skip a CG within the one or more CGs in response to fulfillment of a set of conditions, e.g., as described above in procedure #1. For instance, the UE may determine to skip all remaining PUSCH resource(s) within the one or more CGs, e.g., after a DG or a SR or a BSR.

In some other embodiments, the UE may receive an enhanced CG configuration associated with the bundle of CG related to one set of CG configuration or one or more sets of CG configurations and may determine the bundle of CG or the one or more CGs based on the enhanced CG configuration. The bundle of CG may be for only new transmission(s), or may be for repetition transmission(s). In an embodiment, the UE may determine each CG within the bundle of CG for only new transmission(s) based on the enhanced CG configuration. In another embodiment, the UE may determine the first CG within the bundle of CG for one new transmission and determine the remaining CG(s) within the bundle of CG for repetition transmission based on the enhanced CG configuration.

In some embodiments, the enhanced CG configuration may include at least one of:
(1) Information (denoted as information #1 for simplicity) to indicate each of the (consecutive) PUSCH resources within the bundle of CG for only new transmission(s), e.g., nrofPUSCH. In some embodiments, information #1 is a total number of (consecutive) PUSCH resources within the bundle of CG.
(2) Information (denoted as information #2 for simplicity) to indicate a part of (or inconsecutive) PUSCH resources within the bundle of CG for only new transmission(s) or for repetition transmission(s). In some embodiments, information #2 is a resource bitmap indication, e.g., bitmapIndicaitonofPUSCH, and each bit position within the resource bitmap indication corresponds to a resource within the bundle of CG
(3) An offset of a HARQ process ID for PUSCH resource(s) within the bundle of CG, e.g., harq-ProcID-Offset3. In an example, the offset is for additional PUSCH resource(s) within the bundle of CG except or in addition to a PUSCH resource firstly appeared in time domain within the bundle of CG
(4) A time reference SFN, e.g., timeReferenceSFN. The closest time reference SFN preceding reception of the enhanced CG configuration may be used by the UE.
(5) An integer period for the bundle of CG or a CG of one or more CGs, e.g., 17 ms.
(6) A non-integer period for the bundle of CG or a CG of one or more CGs, e.g., 16.67 ms or 1000/60 ms.

In some embodiments of procedure #1, the UE may determine HARQ process ID(s) for PUSCH resource(s) within the bundle of CG based on the offset of HARQ process ID, e.g., harq-ProcID-Offset3. The HARQ process ID(s) for the PUSCH resource(s) within the bundle of CG may be same as or different from each other. Specific examples are described in Embodiment #1 as described below.

In some other embodiments, the enhanced resource configuration includes at least one of:
(1) Information to indicate the (consecutive) resources within a bundle of preconfigured resources. For example, the information is a total number of (consecutive) resources within the bundle of preconfigured resources, e.g., nrofresources. In an embodiment, the UE may determine a (consecutive) resource allocation within the bundle of preconfigured resources in a time domain based on this information. In an embodiment, the bundle of preconfigured resources includes at least one of:
   a) A bundle of PUSCH resources of CG for only new transmission(s) or for repetition transmission(s). In an example, each CG within the bundle of CG is only for one new transmission. In another example, the first CG within the bundle of CG is for one new transmission, and the remaining CG(s) within the bundle of CG is for repetition transmission(s). In this subject application, a repetition means a HARQ retransmission without receiving HARQ feedback information.
   b) A PUCCH resource of SR or a bundle of PUCCH resource of SR.
   c) A PDSCH resource of SPS or a bundle of PDSCH resource of SPS.
   d) A signal or UCI for a notification message associated with a CG skip operation of the UE.
(2) Information to indicate the part of (or inconsecutive) resources within the bundle of preconfigured resources. For example, the information is a resource bitmap indication, e.g., bitmapIndicaitonofPUSCH, and each bit position within the resource bitmap indication corresponds to a resource within the bundle of preconfigured resources. In an embodiment, the UE may determine a part of (or inconsecutive) resource allocation within the bundle of preconfigured resources in time domain based on this information. For example, the information is a total number of resources in the front part of the bundle of preconfigured resources. For example, the information is a total number of resources in the middle of the bundle of preconfigured resources. For example, the information is a total number of resources in the latter part of the bundle of preconfigured resources.
(3) An offset of HARQ process ID for at least one resource within the bundle of preconfigured resources.
(4) A time reference SFN, wherein the closest time reference SFN preceding reception of the enhanced CG configuration is used by the UE.
(5) An integer periodicity for the bundle of preconfigured resources or a preconfigured resource.
(6) A non-integer periodicity for the bundle of preconfigured resources or a preconfigured resource.

In some embodiments, the UE may determine: a resource firstly appeared in the time domain within the bundle of preconfigured resources (denoted as “resource #1 for simplicity) based on the integer period or the non-integer period; and/or additional resource(s) within the bundle of preconfigured resources except resource #1 based on the first information.

In some embodiments, the UE may determine a HARQ process ID for a resource within the bundle of preconfigured resources based on the offset of HARQ process ID. HARQ process ID(s) for the resource(s) within the bundle of preconfigured resources may be same as or different from each other. Specific examples are described in the embodiments of FIG. 8 as described below.

In some embodiments, the UE may transmit information regarding a capability supporting a CG skip operation to a network node.

In some embodiments, the UE may transmit a notification message to the network node, to indicate that the bundle of preconfigured resources or a subset of the bundle of preconfigured resources is being skipped or to be skipped. In some embodiments, the notification message is transmitted in a MAC CE, a signal on a PUCCH resource, and/or UCI on a PUCCH resource.

In some embodiments, the notification message includes information used to indicate at least one of:
(1) A CG configuration index related to a CG within the bundle of CG, which may be used to indicate the index of unique CG configuration index in a BWP (e.g., configuredGrantConfigIndex-r16) or indicate the unique CG configuration index per a MAC entity (e.g., ConfiguredGrantConfigIndexMAC-r16).
(2) A CG configuration index related to the bundle of CG, which may be used to indicate the index of unique CG configuration index in a BWP (e.g., configuredGrantConfigIndex-r16) or indicate the unique CG configuration index per a MAC entity (e.g., ConfiguredGrantConfigIndexMAC-r16).
(3) A start PUSCH resource being skipped or to be skipped.
(4) An offset associated with the start PUSCH resource. For instance, the preconfigured resource(s) which is skipped or to be skipped may be determined based on both “the start PUSCH resource being skipped or to be skipped” and “the offset associated with the start PUSCH resource”.
(5) An end PUSCH resource being skipped or to be skipped.
(6) An offset associated with the end PUSCH resource. For instance, the preconfigured resource(s) which is skipped or to be skipped may be determined based on both “the end PUSCH resource being skipped or to be skipped” and “the offset associated with the end PUSCH resource”.
(7) A time length of the subset of the bundle of preconfigured resources.
(8) A total number of resources of the subset of the bundle of preconfigured resources.
(9) The bundle of preconfigured resources.

In some embodiments, the notification message is transmitted in response to fulfillment of a set of conditions, which include at least one of:
(1) upon reception of a DG, and the DG is in a time window of the bundle of preconfigured resources or ahead of the bundle of preconfigured resources;
(2) upon reception of the DG and upon transmission on at least one PUSCH resource on the DG;
(3) upon transmission over a resource within the bundle of preconfigured resources;
(4) upon transmission of a SR over a PUCCH resource ahead of the bundle of preconfigured resources; or
(5) upon transmission of all available data for transmission over PUSCH resource(s) within the bundle of preconfigured resources.

In some embodiments, in response to that the DG is in the time window of the bundle of preconfigured resources, the at least one resource on the DG is overlapped or not overlapped with a resource within the bundle of preconfigured resources.

In some embodiments, the set of conditions further include at least one of:
(1) the DG can accommodate all available data for transmission over PUSCH resource(s) within the bundle of preconfigured resources;
(2) a BSR or data is transmitted over the resource within the bundle of preconfigured resources;
(3) all remaining resource(s) following the resource within the bundle of preconfigured resources cannot accommodate remaining available data for transmission; or
(4) a time interval between “the PUCCH resource for the SR” and “a resource firstly appeared in the time domain within the bundle of preconfigured resources” is greater than or equal to a threshold.

In some embodiments, the UE may determine the subset of the bundle of preconfigured resources based on at least one of:
(1) a total number of resources within the subset of the bundle of preconfigured resources and a start resource within the subset of the bundle of preconfigured resources; or
(2) a time period of the subset of the bundle of preconfigured resources in time domain and a start time point (denoted as T #0 for simplicity) of the time period.

In some embodiments, the enhanced resource configuration is associated with at least one of:
(1) the threshold;
(2) the total number of resources within the subset of the bundle of preconfigured resources;
(3) the time period of the subset of the bundle of preconfigured resources in time domain;
(4) information indicating relationship between “a PUCCH resource for transmitting a signal” and “a CG within the bundle of preconfigured resources”; or
(5) information indicating relationship between “a PUCCH resource for transmitting UCI” and “a CG within the bundle of preconfigured resources”.

In some embodiments, T #0 is determined based on:
(1) a start symbol of a resource firstly appeared in the time domain overlapping with the DG;
(2) an end symbol of a resource lastly appeared in the time domain overlapping with the DG;
(3) a start symbol of a PDCCH resource scheduling the DG; or
(4) an end symbol of the PDCCH resource scheduling the DG.

In some other embodiments, T #0 is determined based on (a start symbol or an end symbol of) the resource within the bundle of preconfigured resources for the BSR or the data.

In some embodiments, at least two resources within the bundle of preconfigured resources are related to one set of resource configuration. In some other embodiments, at least two resources within the bundle of preconfigured resources are related to different sets of resource configurations.

The following texts describe specific Embodiments 1-6 of the methods as shown and illustrated in the abovementioned embodiments. According to Embodiments 1-6, a UE and a network node (e.g., a BS) may perform following operations. The UE may be UE 102 as shown and illustrated in FIG. 1. The BS may be BS 101 as shown and illustrated in FIG. 1.

### Embodiment 1

In particular, following operations 1-1, 1-2, and 1-3 may be performed in Embodiment 1.

In operation 1-1 of Embodiment 1, a network node optionally receives UL arrival jitter range information from a UE, a CN or an application server. Jitter range information may include at least one of: an average value, a maximum value, a negative value, or a positive value.

In operation 1-2 of Embodiment 1, the network node transmits an enhanced CG configuration including a part of or sparse PUSCH transmission on a (bundle of) CG occasion to the UE by an RRC message, if the UE reports its capability of supporting the CG. For example, the enhanced CG configuration includes at least one of:
nrojPUSCH: a total number of (consecutive) PUSCH resource(s) configured to a bundle of CG for new transmission; after determining the first PUSCH resource based on the timeDomainOffset and periodicity, the additional (consecutive) PUSCH resource(s) is with a total number of “nrojPUSCH−1” with the same length, and may be with the samefrequencyDomainAllocation, and may be with frequencyHopping.
bitmapIndicaitonofPUSCH: the sub-set within the (consecutive) PUSCH resource(s) (or occasions) that are actually used for PUSCH transmission configured to a (bundle of) CG; for instance, the leftmost bit of the bitmap refers to the first PUSCH resource in the (consecutive) PUSCH resources, and so on. Value 0 in the bitmap indicates that the corresponding PUSCH resource is not used for PUSCH transmission, while value 1 indicates that the corresponding PUSCH resource is used for PUSCH transmission. For instance, the first PUSCH resource may include a preconfigured number of PUSCH resource(s), e.g., 2 consecutive PUSCH resources.
innerPeriodicityAndOffset: the PUSCH periodicity and offset in number of symbols or slots during the window of the bundle of PUSCH to determine the PUSCH transmission occasions in the bundle of CG
harq-ProcID-Offset3: an offset of HARQ process for the valid additional PUSCH within the bundle of CG for a new transmission.

In an example of Embodiment 1, the enhanced CG configuration may be of following format:

| | |
|---|---|
| ConfiguredGrantConfig ::= | SEQUENCE { |
| nrofHARQ-Processes | INTEGER(1..16), |
| repK | ENUMERATED {n1, n2, n4, n8}, |
| multiplePUSCH | ENUMERATED {n2, n4, n8}, |
| PUSCH-PositionsInCG | BIT STRING (SIZE (8)), |
| timeDomainOffset | INTEGER (0..5119), |
| timeDomainAllocation | INTEGER (0..15), |
| frequencyDomainAllocation | BIT STRING (SIZE(18)), |

}

In operation 1-3 of Embodiment 1, after the UE receives the enhanced CG configuration including a part of or sparse PUSCH transmission within the bundle of CG, the UE may determine an PUSCH resource for each CG within the bundle of CG.

For example, after an uplink grant is configured for CG Type 1, the MAC entity of the UE shall consider sequentially that the N^{th} (N>=0) uplink grant occurs in the symbol by Equation 1):

$$[ ( SFN \times numberOfSlotsPerFrame \times numberOfSymbolsPerSlot ) \text{} + ( slot number in the frame \times numberOfSymbolsPerSlot ) + symbol number in the slot ] = ( timeReferenceSFN \times numberOfSlotsPerFrame \times numberOfSymbolsPerSlot + timeDomainOffset \times numberOfSymbolsPerSlot + S + N \times periodicity ) modulo ( 1024 \times numberOfSlotsPerFrame \times numberOfSymbolsPerSlot ) . \qquad Equation 1 )$$

Wherein:
periodicity: a periodicity of CG Type 1;
timeDomainOffset: an offset of a resource with respect to SFN=timeReferenceSFN in time domain;
timeDomainAllocation: an allocation of configured uplink grant in time domain which contains startSymbolAndLength or startSymbol; and
timeReferenceSFN: SFN used for determination of the offset of a resource in time domain. The UE uses the closest SFN with the indicated number preceding the reception of the configured grant configuration.

If nrofPUSCH is configured for CG Type 1, after determining the first PUSCH resource (e.g., a PUSCH resource firstly appeared in time domain) within the bundle of CG based on the timeDomainOffset, the MAC entity of the UE may consider that the uplink grants occur in those additional (consecutive) PUSCH resources with a total number of “nrofPUSCH−1” with the same length.

FIG. 8 illustrates an exemplary schematic diagram of spare PUSCH resources within a bundle of CG Type 1 in accordance with some embodiments of the subject application. For example, if nrofPUSCH 8 in the embodiments of FIG. 8, the MAC entity of the UE can determine the additional “nrofPUSCH−1” PUSCH resources, i.e., “8−1=7”, there are 7 additional PUSCH resources. The MAC entity of the UE counts valid PUSCH resource(s) with bit value(s) of bitmapIndicaitonofPUSCH set to 1 and determines the total number of valid PUSCH resource(s). As shown in FIG. 8, Bitmap is 10101010, if a bit corresponds to one CG, there are four bits “1” corresponding to CG0, CG2, CG4, and CG6, respectively. Thus, the total number of valid PUSCH resources=4, e.g., CG0, CG2, CG4, and CG6 as shown in FIG. 8.

In operation 1-3 of Embodiment 1, after the UE receives the enhanced CG configuration including a part of or sparse PUSCH resources within the bundle of CG, the UE may determine a HARQ process ID for each CG within the bundle of CG. For example, the UE may determine the first HPID for the first CG within the bundle of CG and determine the each HPID for the additional CG within the bundle of CG based on the first HPID. For example, the UE may determine that a HARQ process ID for each CG within the bundle of CG increases sequentially in an ascending order of CG occurring timing.

For example, for configured uplink grants, the HARQ process ID associated with the first symbol of a UL transmission (e.g., HPID-1) or the first PUSCH transmission corresponding to N^{th} uplink grant (e.g., HPID-2, N=0) is derived, e.g., from following Equation 2):

$$HARQ Process ID = [ floor ( CURRENT\_symbol / periodicity ) ] modulo nrofHARQ - Processes \qquad Equation 2 )$$

Wherein:

$$- CURRENT\_symbol = ( SFN \times numberOfSlotsPerFrame \times numberOfSymbolsPerSlot + slot number in the frame \times numberOfSymbolsPerSlot + symbol number in the slot ) ;$$

numberOfSlotsPerFrame refers to a total number of consecutive slots per frame, as specified in 3GPP TS 38.211; and
numberOfSymbolsPerSlot refers to a total number of consecutive symbols per slot, as specified in 3GPP TS 38.211.

Optionally, in some embodiments, periodicity in Equation 2) may be replaced by non-integer-periodicity of a CG. For instance, periodicity in Equation 2) is replaced by non-integer-periodicity of a CG as described in Embodiment 3 as below, which may be set to, e.g., ENUMERATED {1000/30, 1000/60, 1000/90}.

For example of HPID-1 as shown in FIG. 8, the UE needs to determine each HPID with the first symbol of the first UL transmission (e.g., CG0 as shown in FIG. 8) within each bundle of CG. For instance, by Equation 2), the UE may determine HPID of CG0 in the first and second bundles of CG as “0” and “1” highlighted in block box, respectively. If harq-ProcID-Offset3=4, based on HPID of CG0 in the first bundle of CG “0”, the UE may determine that HPIDs of other three valid PUSCH resources CG2, CG4, and CG6 in the first bundle of CG as shown in FIG. 8 are 4, 8, and 12, respectively. If harq-ProcID-Offset3=4, based on HPID of CG0 in the second bundle of CG “1”, the UE may determine that HPIDs of other three valid PUSCH resources CG2, CG4, and CG6 in the second bundle of CG as shown in FIG. 8 are 5, 9, and 13, respectively.

For example of HPID-2 as shown in FIG. 8, the UE only determines the HPID with the first symbol of the first UL transmission (e.g., CG0 as shown in FIG. 8) within a specific N^{th} (e.g., N=0) bundle of CG as 0 highlighted in block box. The UE may not determine the HPID for CGs within other bundle of CG but apply the same HPID (i.e., 0) for the first PUSCH to the other CGs within the bundle of CG For instance, by Equation 2), the UE may determine HPID of CG0 in the first bundle of CG as “0” highlighted in block box. If harq-ProcID-Offset3=1, based on HPID of CG0 in the first bundle of CG “0”, the UE may determine that HPIDs of other three valid PUSCH resources CG2, CG4, and CG6 in the first bundle of CG as shown in FIG. 8 are 1, 2, and 3, respectively. The same as HPIDs of four valid PUSCH resources in the first bundle of CG, the UE may determine that HPIDs of four valid PUSCH resources CG0, CG2, CG4, and CG6 in the second bundle of CG as shown in FIG. 8 are 0, 1, 2, and 3, respectively.

For instance, a HARQ process ID of each valid additional PUSCH i within the bundle of CG may be calculated based on following Equation 3) or Equation 4), wherein i is the ascending order of the PSUCH i with a range from 1 to “a total number of valid PUSCH resource(s)−1”.

$$Equation 3 )$$

$$( HARQ Process ID of first transmission + i * harq - ProcID - Offset 3 )$$

$$( HARQ Process ID of first transmission + i ) \qquad Equation 4 )$$

### Embodiment 2

In Embodiment 2, the MAC entity of a UE may determine the valid PUSCH resource(s) based on cg-nrofPUSCH-InSlot and/or cg-nrofSlots if configured which may be in place of nrofPUSCH and/or bitmapIndicaitonofPUSCH.
cg-nrofPUSCH-InSlot: a total number of (consecutive) PUSCH resource(s) configured to a CG within a slot, wherein the start and length indicator value (SLIV) indicating the first PUSCH and additional PUSCH appended with the same length; or
cg-nrofSlots: a total number of allocated slots in a CG periodicity following the time instant of configured grant offset.

### Embodiment 3

In Embodiment 3, the MAC entity of a UE may determine the first PUSCH within a bundle of CG based on non-integer period if configured by an RRC message.

For example, non-integer-periodicity can be set to ENUMERATED {1000/30, 1000/60, 1000/90}. After an uplink grant is configured for CG Type 1, the MAC entity of the UE shall consider sequentially that the N^{th} (N>=0) uplink grant occurs in the symbol by following Equation 5), Equation 5)−1, Equation 6), or Equation 6)−1:

$$[ ( SFN \times numberOfSlotsPerFrame \times numberOfSymbolsPerSlot ) \text{} + ( slot number in the frame \times numberOfSymbolsPerSlot ) \text{} + symbol number in the slot ] = [ \text{} timeReferenceSFN \times numberOfSlotsPerFrame \times numberOfSymbolsPerSlot \text{} + timeDomainOffset \times numberOfSymbolsPerSlot \text{} + S \text{} + ceiling ( \text{} N \times non - integer - periodicity ) ] modulo ( 1024 \times numberOfSlotsPerFrame \times numberOfSymbolsPerSlot ) \qquad Equation 5 )$$

$$[ ( SFN \times numberOfSlotsPerFrame \times numberOfSymbolsPerSlot ) \text{} + ( slot number in the frame \times numberOfSymbolsPerSlot ) + symbol number in the slot ] = ceiling [ ( timeReferenceSFN \times numberOfSlotsPerFrame \times numberOfSymbolsPerSlot \text{} + timeDomainOffset \times numberOfSlotsPerSlot + S + N \times non - integer - periodicity ) modulo ( 1024 \times numberOfSlotsPerFrame \times numberOfSymbolsPerSlot ) ] \qquad Equation 5 ) - 1$$

$$[ ( SFN \times numberOfSlotsPerFrame \times numberOfSymbolsPerSlot ) \text{} + ( slot number in the frame \times numberOfSymbolsPerSlot ) + symbol number in the slot ] = timeReferenceSFN \times numberOfSlotsPerFrame \times numberOfSymbolsPerSlot \text{} + timeDomainOffset \times numberOfSymbolsPerSlot \text{} + S \text{} + floor ( \text{} N \times non - integer - periodicity ) ] modulo ( 1024 \times numberOfSlotsPerFrame \times numberOfSymbolsPerSlot ) . \qquad Equation 6 )$$

$$[ ( SFN \times numberOfSlotsPerFrame \times numberOfSymbolsPerSlot ) \text{} + ( slot number in the frame \times numberOfSymbolsPerSlot ) + symbol number in the slot ] = floor [ ( timeReferenceSFN \times numberOfSlotsPerFrame \times numberOfSymbolsPerSlot + timeDomainOffset \times numberOfSymbolsPerSlot + S + ( N \times non - integer - periodicity ) modulo ( 1024 \times numberOfSlotsPerFrame \times numberOfSymbolsPerSlot ) ] \qquad Equation 6 ) - 1$$

### Embodiment 4

Embodiment 4 can be applied to configuration(s) for spares PUSCH resources within a bundle of CG Type 2. After an uplink grant is configured for CG Type 2, the MAC entity of the UE shall consider sequentially that the N^{th} (N>=0) uplink grant occurs in the symbol by following Equation 7), Equation 7)−1, Equation 8), or Equation 8)−1:

$$[ ( SFN \times numberOfSlotsPerFrame \times numberOfSymbolsPerSlot ) \text{} + ( slot number in the frame \times numberOfSymbolsPerSlot ) + symbol number in the slot ] = [ \text{} ( {SFN}_{start time} \times numberOfSlotsPerFrame \times numberOfSymbolsPerSlot \text{} + {slot}_{start time} \times numberOfSymbolsPerSlot + {symbol}_{start time} ) + ceiling ( N \times non - integer - periodicity ) ] modulo ( 1024 \times numberOfSlotsPerFrame \times numberOfSymbolsPerSlot ) \qquad Equation 7 )$$

$$[ \text{} ( SFN \times numberOfSlotsPerFrame \times numberOfSymbolsPerSlot ) \text{} + ( slot number in the frame \times numberOfSymbolsPerSlot ) + symbol number in the slot ] = ceiling [ ( {SFN}_{start time} \times numberOfSlotsPerFrame \times numberOfSymbolsPerSlot \text{} + {slot}_{start time} \times numberOfSymbolsPerSlot + {symbol}_{start time} ) + ( N \times non - integer - periodicity ) modulo ( 1024 \times numberOfSlotsPerFrame \times numberOfSymbolsPerSlot ) ] \qquad Equation 7 ) - 1$$

$$[ ( SFN \times numberOfSlotsPerFrame \times numberOfSlotsPerSlot ) \text{} + ( slot number in the frame \times numberOfSymbolsPerSlot ) + symbol number in the slot ] = [ \text{} ( {SFN}_{start time} \times numberOfSlotsPerFrame \times numberOfSymbolsPerSlot \text{} + {slot}_{start time} \times numberOfSymbolsPerSlot + {symbol}_{start time} ) \text{} + floor ( N \times non - integer - periodicity ) ] modulo ( 1024 \times numberOfSlotsPerFrame \times numberOfSymbolsPerSlot ) \qquad Equation 8 )$$

$$[ \text{} ( SFN \times numberOfSlotsPerFrame \times numberOfSymbolsPerSlot ) + ( slot number in the frame \times numberOfSymbolsPerSlot ) \text{} + symbol number in the slot ] = floor [ ( {SFN}_{start time} \times numberOfSlotsPerFrame \times numberOfSymbolsPerSlot \text{} + {slot}_{start time} \times numberOfSymbolsPerSlot + {symbol}_{start time} ) \text{} + ( N \times non - integer - periodicity ) modulo ( 1024 \times numberOfSlotsPerFrame \times numberOfSymbolsPerSlot ) ] \qquad Equation 8 ) - 1$$

Wherein:
SFN_{start time}, slot_{start time}, and symbol_{start time} are the SFN, slot, and symbol, respectively, of the first transmission opportunity of PUSCH where the configured uplink grant was (re-)initialised.

### Embodiment 5

Embodiment 5 can be applied to configuration(s) for DL SPS including the non-integer periodicity or a part of or spares SPS with a bundle of SPS. For example, the enhanced SPS configuration includes at least one of:
nrofPDSCH: a total number of (consecutive) PDSCH resource(s) configured to a bundle of SPS for new transmission; after determining the first PDSCH resource based on the SFN_{start time}, slot_{start time} and periodicity, the additional (consecutive) PDSCH resource(s) is with a total number of “nrofPDSCH−1” with the same length, and may with the samefrequencyDomainAllocation.
bitmapIndicaitonofPDSCH: the sub-set within the (consecutive) PDSCH resource(s) (or occasions) that are actually used for PDSCH transmission configured to a (bundle of) SPS; for instance, the leftmost bit of the bitmap refers to the first PDSCH resource in the (consecutive) bundle of PDSCH resources, and so on. Value 0 in the bitmap indicates that the corresponding PDSCH resource is not used for PDSCH transmission, while value 1 indicates that the corresponding PDSCH resource is used for PDSCH transmission. For instance, the first PDSCH resource may include a preconfigured number of PDSCH resources, e.g., 2 consecutive PDSCH resources.
innerPeriodicityAndOffset: the PDSCH periodicity and offset in number of symbols or slots during the window of the bundle of PDSCH to determine the PDSCH transmission occasions in the bundle of SPS.
harq-ProcID-Offset3: an offset of HARQ process for the valid additional PDSCH within the bundle of SPS for a new transmission.

After a downlink assignment is configured for SPS, the MAC entity of the UE shall consider sequentially that the N^{th} downlink assignment occurs in the slot based on at least one of: non-integer-periodicity, SFNₛₜₐᵣₜ time and slotₛₜₐᵣₜ time, e.g., by following Equation 9), Equation 9)−1, Equation 10), or Equation 10)−1:

$$( numberOfSlotsPerFrame \times SFN + slot number in the frame ) = [ \text{} ( numberOfSlotsPerFrame \times {SFN}_{start time} + {slot}_{start time} ) + ceiling ( \text{} N \times non - integer - periodicity \times numberOfSlotsPerFrame / 10 ) ] modulo ( 1024 \times numberOfSlotsPerFrame ) \qquad Equation 9 )$$

$$( numberOfSlotsPerFrame \times SFN + slot number in the frame ) = ceiling [ \text{} ( numberOfSlotsPerFrame \times {SFN}_{start time} + {slot}_{start time} ) + ( N \times non - integer - periodicity \times numberOfSlotsPerFrame / 10 ) modulo ( 1024 \times numberOfSlotsPerFrame ) ] \qquad Equation 9 ) - 1$$

$$( numberOfSlotsPerFrame \times SFN + slot number in the frame ) = [ \text{} ( numberOfSlotsPerFrame \times {SFN}_{start time} + {slot}_{start time} ) + floor ( \text{} N \times non - integer - periodicity \times numberOfSlotsPerFrame / 10 ) ] modulo ( 1024 \times numberOfSlotsPerFrame ) \qquad Equation 10 )$$

$$( numberOfSlotsPerFrame \times SFN + slot number in the frame ) = floor [ \text{} ( numberOfSlotsPerFrame \times {SFN}_{start time} + {slot}_{start time} ) + ( N \times non - integer - periodicity \times numberOfSlotsPerFrame / 10 ) modulo ( 1024 \times numberOfSlotsPerFrame ) ] \qquad Equation 10 ) - 1$$

Wherein:
SFN_{start time} and slot_{start time} are the SFN and slot, respectively, of the first transmission of PDSCH where the configured downlink assignment was (re-)initialised.

For configured downlink assignments without harq-ProcID-Offset, the HARQ Process ID associated with the slot where the DL transmission or the first PDSCH transmission corresponding to N (e.g., N=0) starts is derived from following Equation 11):

$$HARQ Process ID = [ floor ( CURRENT\_slot \times 10 / ( numberOfSlotsPerFrame \times periodicity ) ) ] modulo nrofHARQ - Processes \qquad Equation 11 )$$

Wherein:
CURRENT_slot=[(SFN×numberOfSlotsPerFrame)+slot number in the frame] and numberOfSlotsPerFrame refers to the number of consecutive slots per frame as specified in TS 38.211 [8].

Optionally, in some embodiments, periodicity in Equation 11) may be replaced by non-integer-periodicity of SPS.

In some embodiments, the MAC entity of the UE determines valid additional PDSCH (resources) allocation based on at least one of: nrofPDSCH, or bitmapIndicaitonofPDSCH. The HARQ Process ID of each valid additional PDSCH i within the bundle of SPS is derived from following Equation 12) or Equation 13):

$$( HARQ Process ID of first transmission \text{} + i * harq - ProcID - Offset 3 ) mod nrofHARQ - Processes , if harq - ProcID - Offset 3 is configured for SPS . \qquad Equation 12 )$$

$$( HARQ Process ID of first transmission + i ) \qquad Equation 13 )$$

Wherein:
i is the ascending order of the PDSCH i which ranges from 1 to (number of valid PDSCH allocation−1).

### Embodiment 6

In Embodiment 6, the MAC entity of a UE may determine a SR based on a non-integer period if configured by an RRC message to match the non-integer XR arrival period, so that a network node can derive more accurate data arrival time at the UE from the upper layer based on the reception of the SR corresponding to the LCH of the data. The SR may be used for requesting physical uplink share channel (PUSCH) resources for new transmission(s). In particular, following operations 2-1, 2-2, and 2-3 may be performed in Embodiment 6.

In operation 2-1 of Embodiment 6, the MAC entity of a UE may be configured with zero, one, or more SR configurations in SchedulingRequestResourceConfig IE including the information of both non-integer-periodicity and offset of SR by RRC signalling. An SR configuration consists of a set of PUCCH resources for SR across different BWPs and cells. Each SR configuration corresponds to one or more logical channels. For example, non-integer-periodicity can be set to ENUMERATED {1000/30, 1000/60, 1000/90}.

Optionally, the UE can be further configured with configuration(s) associated with a bundle of SR including at least one of:
nrofSR: a total number of consecutive SR configured to a bundle of SR; after determining the first SR occasion based on the SR_{OFFSET}, the additional consecutive nrofSR−1 is with the same length, and may be with same freqeunceallocation.
bitmapIndicaitonofSR: the sub-set within the (consecutive) SR resouces (or occasions) that are actually used for SR transmission configured to a bundle of SR. For example, the leftmost bit of the bitmap refers to the first SR resource in the bundle of SR, and so on. Value 0 in the bitmap indicates that the corresponding SR occasion is not used for SR transmission, while value 1 indicates that the corresponding SR resource is used for SR transmission. For instance, the first SR resource may include a preconfigured number of SR resource(s), e.g., 2 consecutive SR resources.
innerPeriodicityAndOffset: the SR periodicity and offset in number of symbols or slots during the window of the bundle of SR to determine the SR transmission occasions in the bundle of SR resources.
M: the value used to determine the timing instance of SR transmission occasion.

In operation 2-2 of Embodiment 6, the UE determines the first SR transmission occasion based on the non-integer period and an offset of the SR configuration.

For instance, the UE may also be configured a periodicity SR_{non-integer-PERIODICITY} in symbols or slots and an offset SR_{OFFSET} in slots for a PUCCH transmission conveying SR.

If SR_{PERIODICITY} is larger than one slot, the UE determines a SR transmission occasion in a PUCCH to be in a slot with number

$${n}_{s , f}^{μ}$$

[e.g., as defined in 3GPP TS 38.211] in a frame with number n_{f} based on at least one of SR_{non-integer-PERIODICITY}, SRtimeReferenceSFN, M, SR_{OFFSET}, SRtimeDomainOffset. The following formulas refer to some examples for an optional enhanced formula to determine SR transmission occasion(s).

1) if ceiling{

$$( {n}_{f} \cdot {N}_{slot}^{frame , μ} + {n}_{s , f}^{μ} - {SR}_{OFFSET} ) mod ( {SR}_{non - integer - PERIODICITY} ) \} = 0$$

or if floor{

$$( {n}_{f} \cdot {N}_{slot}^{frame , μ} + {n}_{s , f}^{μ} - {SR}_{OFFSET} ) mod ( {SR}_{non - integer - PERIODICITY} ) \} = 0.$$

Wherein n_{f} is SFN_M, SR_{OFFSET} is offset from SFN=0 and slot=0. where the SFN_M is determined as follow example.

```
  1> if SR_{non-integer-PERIODICITY} is configured:
    2> M = 1000; (which may be configured by RRC signalling from a
  network node)
    2> if SFN >= SRtimeReferenceSFN, SFN_M = (SFN −
  SRtimeReferenceSFN) mod M;
    2> if SFN < SRtimeReferenceSFN, SFN_M = (SFN −
  SRtimeReferenceSFN + 1024) mod M.
1> else:
        2> M = 1024;
        2> SFN_M = SFN.
  1> if SFN is changed:
      2> SFN_M = (SFN_M + 1) mod M.
```

2) if

$$( {n}_{f} \cdot {N}_{slot}^{frame , μ} + {n}_{s , f}^{μ} ) = [ \text{} SRtimeReferenceSFN \cdot {N}_{slot}^{frame , μ} + SRtimeDomainOffset + ceiling ( N \cdot {SR}_{non - integer - PERIODICITY} ) ] module ( 1024 \cdot {N}_{slot}^{frame , μ} ) ;$$

$$or if$$

$$( {n}_{f} \cdot {N}_{slot}^{frame , μ} + {n}_{s , f}^{μ} ) = [ \text{} SR timeReferenceSFN \cdot {N}_{slot}^{frame , μ} + SRtimeDomainOffset + floor ( N \cdot {SR}_{non - integer - PERIODICITY} ) ] module ( 1024 \cdot {N}_{slot}^{frame , μ} ) ;$$

$$or if$$

$$if ( {n}_{f} \cdot {N}_{slot}^{frame , μ} + {n}_{s , f}^{μ} ) = ceiling [ ( SRtimeReferenceSFN \cdot {N}_{slot}^{frame , μ} + SRtimeDomainOffset + N \cdot {SR}_{non - integer - PERIODICITY} ) module ( 1024 \cdot {N}_{slot}^{frame , μ} ) ] ;$$

$$or if$$

$$( {n}_{f} \cdot {N}_{slot}^{frame , μ} + {n}_{s , f}^{μ} ) = floor [ ( SRtimeReferenceSFN \cdot {N}_{slot}^{frame , μ} + SRtimeDomainOffset + N \cdot {SR}_{non - integer - PERIODICITY} ) module ( 1024 \cdot {N}_{slot}^{frame , μ} ) ]$$

Wherein: N=0, 1, 2, . . . , N>=0
SRtimeReferenceSFN: which indicates SFN used for determination of the offset of a resource in time domain, may be received by RRC signalling from the network node. The UE uses the closest SFN with the indicated number preceding the transmission of the SR configuration, e.g., TS 38.213. If the field timeReferenceSFN is not present, the reference SFN is 0.
SRtimeDomainOffset: which indicates slot offset from the SRtimeReferenceSFN=0 or 512, may be received by RRC signalling from the network node.

If SR_{PERIODICITY} is one slot, the UE expects that SR_{OFFSET}=0 and every slot is a SR transmission occasion in a PUCCH.

If SR_{PERIODICITY} is smaller than one slot, the UE determines a SR transmission occasion in a PUCCH to start in a symbol with index l [4, TS 38.211] at least one of the following formula:
1) if (l−l₀modSR_{PERIODICITY})modSR_{PERIODICITY}=0 where l₀ is the value of startingSymbolIndex. Or
2) if

$$( {n}_{f} \cdot {N}_{slot}^{frame , μ} + {n}_{s , f}^{μ} + l - {l}_{0} mod {SR}_{PERIODICITY} ) mod {SR}_{PERIODICITY} = 0 ;$$

$$or if$$

$$( {n}_{f} \cdot {N}_{slot}^{frame , μ} \cdot {N}_{symb}^{slot} + {n}_{s , f}^{μ} \cdot {N}_{symb}^{slot} + l symbol number in the slot ) = [ \text{} SRtimeReferenceSFN \cdot {N}_{slot}^{frame , μ} \cdot {N}_{symb}^{slot} + SRtimeDomainOffset \cdot {N}_{symb}^{slot} + {l}_{0} + ceiling ( N \cdot {SR}_{non - integer - PERIODICITY} ) ] module ( 1024 \cdot {N}_{slot}^{frame , μ} \cdot {N}_{symb}^{slot} ) ;$$

$$or if$$

$$( {n}_{f} \cdot {N}_{slot}^{frame , μ} \cdot {N}_{symb}^{slot} + {n}_{s , f}^{μ} \cdot {N}_{symb}^{slot} + l symbol number in the slot ) = [ \text{} SRtimeReferenceSFN \cdot {N}_{slot}^{frame , μ} \cdot {N}_{symb}^{slot} + SRtimeDomainOffset \cdot {N}_{symb}^{slot} + {l}_{0} + floor ( N \cdot {SR}_{non - integer - PERIODICITY} ) ] module ( 1024 \cdot {N}_{slot}^{frame , μ} \cdot {N}_{symb}^{slot} ) ;$$

$$or if$$

$$( {n}_{f} \cdot {N}_{slot}^{frame , μ} \cdot {N}_{symb}^{slot} + {n}_{s , f}^{μ} \cdot {N}_{symb}^{slot} + l symbol number in the slot ) = ceiling [ \text{} ( SRtimeReferenceSFN \cdot {N}_{slot}^{frame , μ} \cdot {N}_{symb}^{slot} + SRtimeDomainOffset \cdot {N}_{symb}^{slot} + {l}_{0} + N \cdot {SR}_{non - integer - PERIODICITY} ) module ( 1024 \cdot {N}_{slot}^{frame , μ} \cdot {N}_{symb}^{slot} ) ] ;$$

$$or if$$

$$( {n}_{f} \cdot {N}_{slot}^{frame , μ} \cdot {N}_{symb}^{slot} + {n}_{s , f}^{μ} \cdot {N}_{symb}^{slot} + l symbol number in the slot ) = floor [ \text{} ( SRtimeReferenceSFN \cdot {N}_{slot}^{frame , μ} \cdot {N}_{symb}^{slot} + SRtimeDomainOffset \cdot {N}_{symb}^{slot} + {l}_{0} + N \cdot {SR}_{non - integer - PERIODICITY} ) module ( 1024 \cdot {N}_{slot}^{frame , μ} \cdot {N}_{symb}^{slot} ) ]$$

SRtimeReferenceSFN is the same as above.
SRtimeDomainOffset is symbol offset from the SRtimeReferenceSFN.

In some embodiments, the parameters except the non-integer-period and the offset can be referenced in the following Table 1, which includes: number of OFDM symbols per slot, slots per frame, and slots per subframe for normal cyclic prefix.

TABLE 1

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |
| 6 | 14 | 640 | 64 |

In operation 2-3 of Embodiment 6, if SR_COUNTER<sr-TransMax if configured, the MAC entity of the UE shall instruct the physical layer to signal the SR on one valid PUCCH resource for SR for each pending SR.

Details described in all other embodiments of the subject application are applicable for the embodiments of any of FIGS. 4-8. Moreover, details described in the embodiments of any of FIGS. 4-8 are applicable for all the embodiments of FIGS. 1-3 and 9.

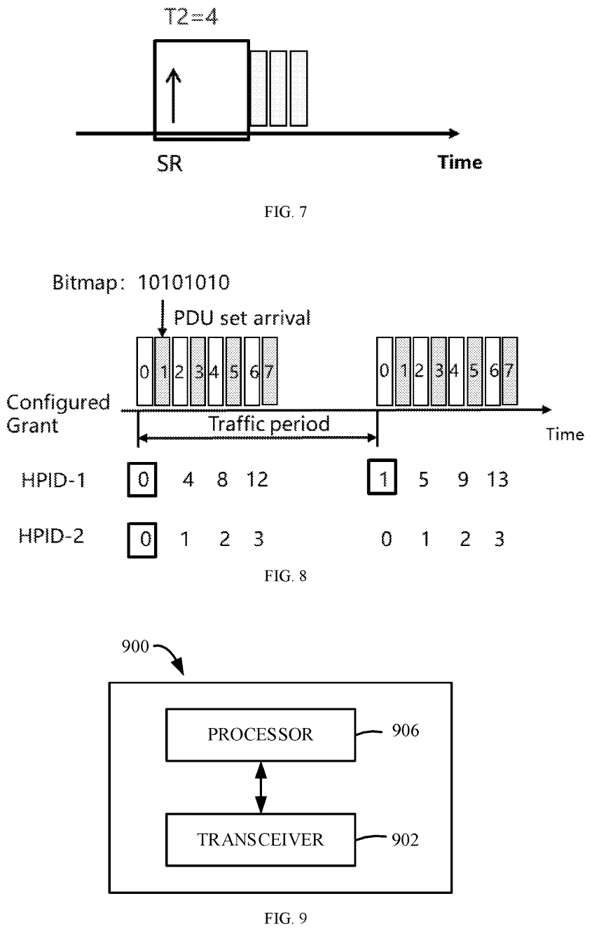

FIG. 9 illustrates a block diagram of an exemplary apparatus 900 in accordance with some embodiments of the present disclosure. As shown in FIG. 9, the apparatus 900 may include at least one processor 906 and at least one transceiver 902 coupled to the processor 906. Although in this figure, elements such as the at least one transceiver 902 and processor 906 are described in the singular, the plural is contemplated unless a limitation to the singular is explicitly stated. In some embodiments of the subject application, the transceiver 902 may be divided into two devices, such as a receiving circuitry and a transmitting circuitry. In some embodiments of the subject application, the apparatus 900 may further include an input device, a memory, and/or other components.

In some embodiments of the subject application, the apparatus 900 may be a UE or a network node (e.g., a BS). The transceiver 902 and the processor 906 may interact with each other so as to perform the operations with respect to the UE or the network node described above, for example, in any of FIGS. 1-8.

In some embodiments of the subject application, the apparatus 900 may further include at least one non-transitory computer-readable medium. For example, in some embodiments of the present disclosure, the non-transitory computer-readable medium may have stored thereon computer-executable instructions to cause the processor 906 to implement the method with respect to a UE or a network node (e.g., a BS) as described above. For example, the computer-executable instructions, when executed, cause the processor 906 interacting with transceiver 902 to perform the operations with respect to the UE or the network node described in FIGS. 1-8.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the subject application, but is not used to limit the substance of the subject application.

1-6. (canceled)

7. A user equipment (UE) for wireless communication, comprising:
at least one memory; and
at least one processor coupled with the at least one memory and configured to cause the UE to receive an enhanced resource configuration from a network node, wherein the enhanced resource configuration includes at least one of:
first information to indicate resources within a bundle of preconfigured resources;
second information to indicate a part of the resources within the bundle of preconfigured resources; or
an integer period for the bundle of preconfigured resources.

8. The UE of claim 7, wherein the bundle of preconfigured resources includes at least one of:
a bundle of physical uplink shared channel (PUSCH) resources of a configured grant (CG) for one or more new transmissions or for one or more repetition transmissions; or
a signal or uplink control information (UCI) for a notification message associated with a CG skip operation of the UE.

9. The UE of claim 7, wherein the first information is a total number of resources within the bundle of preconfigured resources.

10. The UE of claim 7, wherein the at least one processor is configured to cause the UE to determine an available or valid or consecutive resource allocation within the bundle of preconfigured resources in a time domain based on the first information.

11. The UE of claim 7, wherein the at least one processor is configured to cause the UE to determine an available or valid or inconsecutive resource allocation within the bundle of preconfigured resources in a time domain based on the second information.

12. The UE of claim 7, wherein the at least one processor is configured to cause the UE to determine at least one of:
a first resource that first appears in a time domain within the bundle of preconfigured resources based on the integer period or a non-integer period; or
at least one additional resource within the bundle of preconfigured resources except the first resource based on the first information.

13. (canceled)

14. The UE of claim 7, wherein the at least one processor is configured to cause the UE to transmit a notification message to the network node, and wherein the notification message indicates that the bundle of preconfigured resources or a subset of the bundle of preconfigured resources is being skipped or is to be skipped.

15. (canceled)

16. The UE of claim 8, wherein the at least one processor is configured to cause the UE to transmit the notification message as a transmission over a preconfigured resource within the bundle of preconfigured resources.

17. The UE of claim 8, wherein:
the at least one processor is configured to cause the UE to transmit the notification message based on at least one of a buffer status report (BSR) or data is transmitted over a preconfigured resource within the bundle of preconfigured resources; and
one or more CGs to be skipped are within a time period, wherein a length of the time period is a total number of one or more PUSCH resources configured in an enhanced CG skip configuration received from the network node, and a start of the time period is calculated from a start of a PUSCH transmission or after an end the PUSCH transmission within a bundle of CGs.

18. The UE of claim 8, wherein the at least one processor is configured to cause the UE to skip one or more CGs based on a received dynamic uplink grant (DG) allowed for transmission of data, wherein available data for transmission over the PUSCH resources is accommodated within the bundle of preconfigured resources allowed for transmission of the data.

19. The UE of claim 8, wherein the at least one processor is configured to cause the UE to determine a start time point of a skipped subset of one or more CGs, determined based on one or more PUSCH resources within the bundle of PUSCH resources of the CG for transmission of all allowed and available data for transmission.

20. The UE of claim 8, wherein the at least one processor is configured to cause the UE to determine a start time point of a skipped subset of one or more CGs.

21. The UE of claim 8, wherein the at least one processor is configured to cause the UE to transmit uplink arrival jitter range information including at least one of an average value, a maximum value, a negative value, or a positive value.

22. The UE of claim 14, wherein the at least one processor is configured to cause the UE to transmit the notification message as a transmission over a preconfigured resource within the bundle of preconfigured resources.

23. The UE of claim 14, wherein:
the at least one processor is configured to cause the UE to transmit the notification message based on at least one of a buffer status report (BSR) or data is transmitted over a preconfigured resource within the bundle of preconfigured resources; and
one or more configured grants (CGs) to be skipped are within a time period, wherein a length of the time period is a total number of one or more physical uplink shared channel (PUSCH) resources configured in an enhanced CG skip configuration received from the network node, and a start of the time period is calculated from a start of a PUSCH transmission or after an end the PUSCH transmission within a bundle of CGs.

24. The UE of claim 14, wherein the at least one processor is configured to cause the UE to skip one or more configured grants (CGs) based on a received dynamic uplink grant (DG) allowed for transmission of data, wherein available data for transmission over physical uplink shared channel (PUSCH) resources is accommodated within the bundle of preconfigured resources allowed for transmission of the data.

25. The UE of claim 14 wherein the at least one processor is configured to cause the UE to determine a start time of a skipped subset of one or more configured grants (CGs), determined based on one or more physical uplink shared channel (PUSCH) resources within the bundle of PUSCH resources of a CG for transmission of all allowed and available data for transmission.

26. A processor for wireless communication, comprising:
at least one controller coupled with at least one memory and configured to cause the processor to receive an enhanced resource configuration from a network node, wherein the enhanced resource configuration includes at least one of:
first information to indicate resources within a bundle of preconfigured resources;
second information to indicate a part of the resources within the bundle of preconfigured resources; or
an integer period for the bundle of preconfigured resources.

27. A method performed by a user equipment (UE), the method comprising:
receiving an enhanced resource configuration from a network node, wherein the enhanced resource configuration includes at least one of:
first information to indicate resources within a bundle of preconfigured resources;
second information to indicate a part of the resources within the bundle of preconfigured resources; or
an integer period for the bundle of preconfigured resources.

28. A network equipment (NE) for wireless communication, comprising:
at least one memory; and
at least one processor coupled with the at least one memory and configured to cause the NE to:
transmit, to a user equipment (UE), an enhanced resource configuration that includes at least one of first information to indicate resources within a bundle of preconfigured resources, second information to indicate a part of the resources within the bundle of preconfigured resources, or an integer period for the bundle of preconfigured resources; and
receive, from the UE, a notification message that indicates the bundle of preconfigured resources or a subset of the bundle of preconfigured resources is being skipped or is to be skipped.
